(19) United States
(12) Patent Application Publication
(10) Pub. No.: US 2014/0081903 A1
(43) Pub. Date: Mar. 20, 2014

(54) METHODS AND SYSTEMS FOR DISPLAYING AND FILTERING BUSINESS ANALYTICS DATA STORED IN THE CLOUD

(71) Applicants: Marko Koosel, San Francisco, CA (US); Suyog Anil Deshpande, Foster City, CA (US)

(72) Inventors: Marko Koosel, San Francisco, CA (US); Suyog Anil Deshpande, Foster City, CA (US)

(73) Assignee: SALESFORCE.COM, INC., San Francisco, CA (US)

(21) Appl. No.: 14/029,094

(22) Filed: Sep. 17, 2013

Related U.S. Application Data
(60) Provisional application No. 61/701,996, filed on Sep. 17, 2012.

(51) Int. Cl. G06F 17/30

(52) U.S. Cl. CPC G06F 17/30563
USPC 707/602

(57) ABSTRACT

In accordance with disclosed embodiments, there are provided methods, systems, and apparatuses for displaying and filtering business analytics data stored in the cloud, including, for example, means for displaying a graphical interface at a client device; communicating a business analytics query from the client device to a remote host organization via a public Internet; receiving a business analytics dataset in a complete and unfiltered form from the host organization responsive to the business analytics query; caching the business analytics dataset in its complete and unfiltered form to the memory of the client device; displaying a business analytics report at the graphical interface of the client device, the business analytics report representative of the business analytics dataset in its complete and unfiltered form; receiving filter input at the client device; applying the filter input to the business analytics dataset to yield a filtered sub-set; and updating the business analytics report displayed at the graphical interface using the filtered sub-set of the business analytics dataset. Other related embodiments are disclosed.

### CLAIM OF PRIORITY

This application is related to, and claims priority to, the provisional utility application entitled “METHODS AND SYSTEMS FOR DISPLAYING ANALYTICS SCORECARDS AND PREDICTIVE RESULTS,” filed on Sep. 17, 2012, having an application number of 61/701,996 and attorney docket No. 1009PROV, the entire contents of which are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

Embodiments of the invention relate generally to the field of computing, and more particularly, to systems, methods, and apparatuses for displaying and filtering business analytics data stored in the cloud.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to embodiments of the claimed inventions.

A single a multi-tenant database system operates to store data on behalf of a multitude of paying subscribers, each being a “tenant” of the database system, hence the term multi-tenant database system. Many subscribers (e.g., users) utilize the multi-tenant database system to access analytics, charts, views, reports, and other such data which is stored within the multi-tenant database system. For instance, a sales team may utilize sales data stored within such a system.

Conventional solutions enable such users to display lists, reports, and charts, but each are generated and rendered as separate entities. The interfaces to access the underlying data tends to be highly disjointed and as such, may be difficult for users to learn and navigate.

For example, in many organizations, there is a team that is responsible for generating a variety of reports, lists, charts, and so forth, but every time such an information interface is generated, it provides a one-off custom solution to access the organizations data in the manner requested by a designer or requestor and then display the data in the manner requested by the designer or requestor. There is not any relationship between the various reports, lists, and charts generated. They do not flow to each other. They do not affect each other. They do not operate within the context of one another. For these reasons, it can be difficult for users to access the required information.

The problem may be exacerbated for a manager or other person in a supervisory role which must access a variety of reports relating to many individuals, each of whom will be associated with their own metrics. Consider for example the role of a sales manager with a sales team of many individual salespersons. With conventional solutions, such a sales manager must navigate many different reporting interfaces, access multiple different reports, and then manually aggregate such data upon which the sales manager will then make decisions. Unfortunately, much of the work of aggregation and summarizing is conducted by manually copying and pasting such data into spreadsheets for further manual manipulation, a process which is tedious, time consuming, and highly error prone.

Still further, due to the stand alone nature of conventional business intelligence reporting objects, such reports, lists, and charts, even when properly developed and rendered, are by their very nature read-only. That is to say, they cannot be manipulated such that data rendered at a display can be edited and then written back into the underlying source records of the database system.

The present state of the art may therefore benefit from the systems, methods, and apparatuses for implementing cross-organizational processing of business intelligence metrics as described herein.

### BRIEF DESCRIPTION OF THE DRAWINGS

Embodiments are illustrated by way of example, and not by way of limitation, and will be more fully understood with reference to the following detailed description when considered in connection with the figures in which:

FIG. 1 depicts an exemplary architecture in accordance with described embodiments;

FIG. 2 depicts an exemplary graphical interface in accordance with the embodiments;

FIG. 3A depicts another exemplary graphical interface in accordance with the embodiments;

FIG. 3B depicts another exemplary graphical interface in accordance with the embodiments;

FIG. 4A depicts an exemplary graphical interface operating at a mobile, smartphone, or tablet computing device in accordance with the embodiments;

FIG. 4B depicts another exemplary graphical interface operating at a mobile, smartphone, or tablet computing device in accordance with the embodiments;

FIG. 4C depicts another exemplary graphical interface operating at a mobile, smartphone, or tablet computing device in accordance with the embodiments;

FIG. 4D depicts another exemplary graphical interface operating at a mobile, smartphone, or tablet computing device in accordance with the embodiments;

FIG. 4E depicts another exemplary graphical interface operating at a mobile, smartphone, or tablet computing device in accordance with the embodiments;

FIG. 4F depicts another exemplary graphical interface operating at a mobile, smartphone, or tablet computing device in accordance with the embodiments;

FIG. 4G depicts another exemplary graphical interface operating at a mobile, smartphone, or tablet computing device in accordance with the embodiments;

FIG. 4H depicts another exemplary graphical interface operating at a mobile, smartphone, or tablet computing device in accordance with the embodiments;

FIG. 5A depicts another exemplary graphical interface operating at a mobile, smartphone, or tablet computing device in accordance with the embodiments;

FIG. 5B depicts another exemplary graphical interface operating at a mobile, smartphone, or tablet computing device in accordance with the embodiments;

FIG. 5C depicts another exemplary graphical interface operating at a mobile, smartphone, or tablet computing device in accordance with the embodiments;

FIG. 6A is a flow diagram illustrating a method at a client device in accordance with disclosed embodiments;

FIG. 6B is a flow diagram illustrating a method at a host organization in accordance with disclosed embodiments;

FIG. 7A illustrates a block diagram of an environment in which an on-demand database service may operate in accordance with the described embodiments;

FIG. 7B illustrates another block diagram of an embodiment of elements of FIG. 7A and various possible interconnections between such elements in accordance with the described embodiments;

FIG. 8 illustrates a diagrammatic representation of a machine in the exemplary form of a computer system, in accordance with one embodiment;

FIG. 9A depicts a tablet computing device and a hand-held smartphone each having a circuitry integrated therein as described in accordance with the embodiments;

FIG. 9B is a block diagram of an embodiment of tablet computing device, a smart phone, or other mobile device in which touchscreen interface connectors are used; and

FIG. 10 shows a diagrammatic representation of a system in accordance with which embodiments may operate, be installed, integrated, or configured.

### DETAILED DESCRIPTION

Described herein are systems, methods, and apparatuses for displaying and filtering business analytics data stored in the cloud, such as within an on-demand service environment. Such systems, devices, and methods may include, for example, means for: displaying a graphical interface at a client device; communicating a business analytics query from the client device to a remote host organization via a public Internet; receiving a business analytics dataset in a complete and unfiltered form from the host organization responsive to the business analytics query; caching the business analytics dataset in its complete and unfiltered form to the memory of the client device; displaying a business analytics report at the graphical interface of the client device, the business analytics report representative of the business analytics dataset in its complete and unfiltered form; receiving filter input at the client device; applying the filter input to the business analytics dataset to yield a filtered sub-set; and updating the business analytics report displayed at the graphical interface using the filtered sub-set of the business analytics dataset.

As noted previously, conventional solutions which provide for the display of various reports, lists, charts and other information display fail to provide any kind of a relationship between such data sources, much less any kind of a navigable graphical interface. Described herein are mechanisms by which a user, such as a sales person or a sales manager having data stored within the databases of a host organization providing cloud based computing services may access their data in a highly intuitive manner and conduct all of their work in a single location through a single interface with appropriate navigation amongst a variety of relevant information sources available to the user.

Such techniques may be highly beneficial to sales managers or any other person in a supervisory role (e.g., business executives, operations managers, etc.) who must access an even greater variety of information sources as the supervisors are enabled through the described embodiments to identify aggregated metrics of their subordinates, access per-individual metrics for their subordinates, and generally perform a variety of tasks through the mechanisms disclosed without having to resort to copying and pasting information into a separate application, such as a spreadsheet, such that it may be manipulated.

Still further disclosed is a predictive results view with change value indication which permits users to alter displayed records and then view how such an alteration would affect the reported results or other displayed information, if committed to a database. In such embodiments, users are further enabled to commit such alterations to the underlying records of a source database if they have sufficient access rights (e.g., update record rights, new record rights, etc.). With conventional reporting mechanisms it would be necessary to access a separate utility to make such a change to the underlying records of the database, causing further technical difficulty and complexity for the users of such systems.

According to certain embodiments, charts, graphs, and other informational display means drive the data provided to a user and then display logic and functionality enables contextually appropriate navigation to the user who may then explore, drill down, aggregate, modify, benchmark, and otherwise interact with their data in a highly intuitive manner.

In such a way, users of the described embodiments no longer have to leave the information display page as the various displays are contextually related to one another which permits for navigation between them, where as with conventional solutions, a reporting interface would have to be exited, and a different reporting mechanism accessed. Users with appropriate access rights can explore predictive results from a considered alteration to the data and commit or not commit such data modifications, and users can alter the benchmarking upon which the various information displays are created.

These and other details are described in further detail in the context of the individual figures.

In the following description, numerous specific details are set forth such as examples of specific systems, languages, components, etc., in order to provide a thorough understanding of the various embodiments. It will be apparent, however, to one skilled in the art that these specific details need not be employed to practice the embodiments disclosed herein. In other instances, well known materials or methods have not been described in detail in order to avoid unnecessarily obscuring the disclosed embodiments.

In addition to various hardware components depicted in the figures and described herein, embodiments further include various operations which are described below. The operations described in accordance with such embodiments may be performed by hardware components or may be embodied in machine-executable instructions, which may be used to cause a general-purpose or special-purpose processor programmed with the instructions to perform the operations. Alternatively, the operations may be performed by a combination of hardware and software.

Embodiments also relate to an apparatus for performing the operations disclosed herein. This apparatus may be specially constructed for the required purposes, or it may be a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear as set forth in the description below. In addition, embodiments are not described with reference to any particular programming language. It will be appreciated that a variety of programming languages may be used to implement the teachings of the embodiments as described herein.

Embodiments may be provided as a computer program product, or software, that may include a machine-readable medium having stored thereon instructions, which may be used to program a computer system (or other electronic devices) to perform a process according to the disclosed embodiments. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.), a machine (e.g., computer) readable transmission medium (electrical, optical, acoustical), etc.

Any of the disclosed embodiments may be used alone or together with one another in any combination. Although various embodiments may have been partially motivated by deficiencies with conventional techniques and approaches, some of which are described or alluded to within the specification, the embodiments need not necessarily address or solve any of these deficiencies, but rather, may address only some of the deficiencies, address none of the deficiencies, or be directed toward different deficiencies and problems where are not directly discussed.

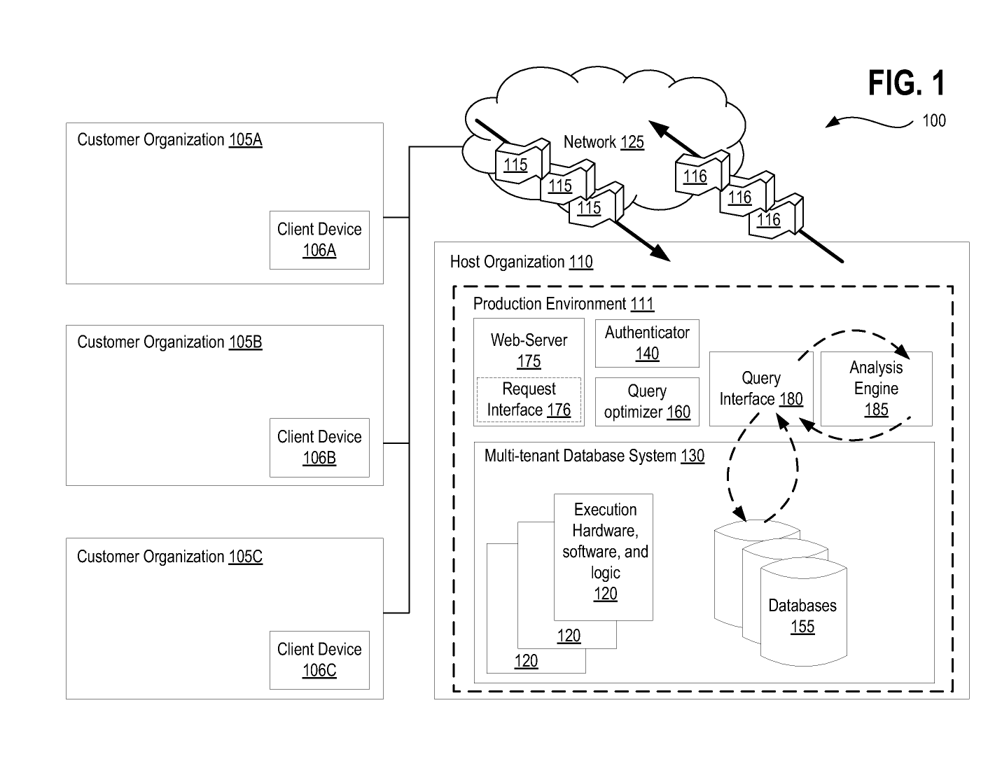

FIG. 1 depicts an exemplary architecture 100 in accordance with described embodiments. In one embodiment, a production environment 111 is communicably interfaced with a plurality of client devices 106A-C (e.g., such as mobile devices, smart phones, tablets, PCs, etc.) through host organization 110. In one embodiment, a multi-tenant database system 130 includes databases 155, for example, to store tables, datasets, and underlying database records with user data on behalf of customer organizations 105A-C or users.

Multi-tenant database system 130 includes a plurality of underlying hardware, software, and logic elements 120 that implement database functionality and a code execution environment within the host organization 110. In accordance with one embodiment, multi-tenant database system 130 further implements databases 155 to service database queries and other data interactions with the databases 155. The hardware, software, and logic elements 120 of the multi-tenant database system 130 are separate and distinct from a plurality of customer organizations (105A, 105B, and 105C) which utilize the services provided by the host organization 110 by communicably interfacing to the host organization 110 via network 125. In such a way, host organization 110 may implement on-demand services, on-demand database services or cloud computing services to subscribing customer organizations 105A-C.

Host organization 110 receives input and other requests 115 from a plurality of customer organizations 105A-C via network 125 (such as a public Internet). For example, incoming database queries, API requests, interactions with displayed graphical user interfaces and displays at the client devices 106A-C, or other inputs may be received from the customer organizations 105A-C to be processed against the multi-tenant database system 130.

In one embodiment, each customer organization 105A-C is an entity selected from the group consisting of: a separate and distinct remote organization, an organizational group within the host organization 110, a business partner of the host organization 110, or a customer organization 105A-C that subscribes to cloud computing services provided by the host organization 110.

In one embodiment, requests 115 are received at, or submitted to, a web-server 175 within host organization 110. Host organization 110 may receive a variety of requests for processing by the host organization 110 and its multi-tenant database system 130. Incoming requests 115 received at web-server 175 may specify which services from the host organization 110 are to be provided, such as query requests, search request, status requests, database transactions, graphical user interface requests and interactions, processing requests to retrieve, update, or store data on behalf of one of the customer organizations 105A-C, code execution requests, and so forth. Web-server 175 may be responsible for receiving requests 115 from various customer organizations 105A-C via network 125 and provide a web-based interface or other graphical displays to an end-user client device 106A-C or machine originating such data requests 115.

Authenticator 140 operates on behalf of the host organization to verify, authenticate, and otherwise credential users attempting to gain access to the host organization.

Query interface 180 provides functionality to pass queries from web-server 175 into the multi-tenant database system 130 for execution against the databases 155 or other data stores of the host organization's production environment 111. In one embodiment, the query interface 180 implements an Application Programming Interface (API) through which queries may be executed against the databases 155 or other data stores. Query optimizer 160 performs query translation and optimization, for instance, on behalf of other functionality such as functionality of a graphical interface which possesses sufficient information to architect a query yet lacks the necessary logic to actually construct the appropriate query syntax. In other instance, query optimizer 160 modifies a submitted query to optimize its execution within the host organization without affecting the resulting dataset returned responsive to such an optimized query. Analysis engine 185 operates on behalf of functionality within the host organization to perform additional data evaluation where necessary, such as evaluating how potential data modification may affect displayed information at a user interface. In other instances, logic associated with the relevant displays performs such necessary analysis.

Host organization 110 may implement a request interface 176 via web-server 175 or as a stand-alone interface to receive requests packets or other requests 115 from the client devices 106A-C. Request interface 176 further supports the return of response packets or other replies and responses 116 in an outgoing direction from host organization 110 to the client devices 106A-C.

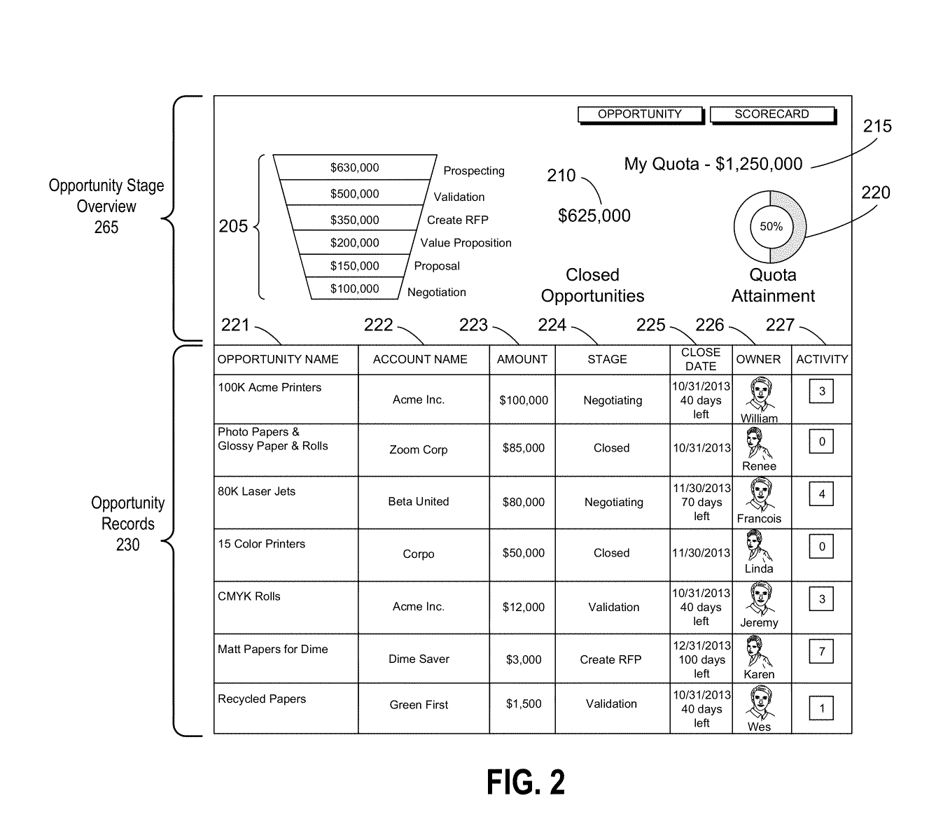

FIG. 2 depicts an exemplary graphical interface in accordance with the embodiments. In particular, a high level dashboard view is depicted which may be display as a graphical interface at a user's client device.

In the depicted dashboard there is a opportunity stage overview 265 having provided therein an aggregate view of an exemplary sales pipeline by phase at element 205 showing an aggregated view of the progression of sales opportunities through the team's sales pipeline by amount. Further depicted in this view is a present quota at element 215, by way of example, showing 1.25 million as the present quota for the fictitious sales manager that may utilize such a dashboard view. Element 210 depicts progress toward goal with $625,000 having been attained toward the present quota. Quota attainment at element 220 depicts the same information in a graphical view.

The dashboard depicted here further provides a listing of opportunity records 230 broken out by the columns including opportunity name 221, account name 222, amount 223, opportunity stage 224, close date 225, owner (e.g., team member) 226, and activity 227. According to described embodiments, the displayed opportunity records 230 may be presented in a scrollable view with further records able to be displayed responsive to a user scrolling or swiping action. Further in accordance with such embodiments, a user presented with the dashboard may navigate to other displays by selecting, touching, clicking various elements of the displayed dashboard which will in turn trigger a contextually appropriate navigation event to another display. For instance, clicking on an opportunity name may navigate to additional details for that opportunity name whereas clicking on the owner for the same opportunity name may instead trigger navigation to details about the particular opportunity owner, who in this context, would be a member of the sales team represented by the dashboard.

Users of such dashboards may have multiple dashboard views to help represent sales data in a variety of formats such that a sales manager may manage their sales teams' efforts.

Consider for example a hands-on manager that understands success is highly dependent upon the success of the individuals making up the sales team being managed. Such a manager would be highly interested in dashboard data to quickly see a high level overview of how the sales team is performing at any given time. Such a manager would further seek to drill down into the individual metrics of sales persons making up the team, navigation which is enabled directly from a dashboard view as described herein. Such a manager would seek to constantly refine their ability to understand, trend, report, and execute according to available forecasts.

Such a manager may seek to provide specialized hands-on and real-time attention to newer less experienced salespersons or to salespersons struggling with a given lead, quarter, deliverable, etc., attention which is made possible by having access to the salespersons' relevant metrics in a simple and intuitive manner.

As the quarter draws near, such a manager can pay close attention to aggregate and individualized quotas and assist both individuals and the larger sales team with meeting targets. Such a sales manager would benefit greatly from the systems, methods, and apparatuses for displaying and filtering business analytics data stored in the cloud as described herein which enable such an attentive and hands-on manager.

In one embodiment, such a sales manager may open up their mobile computing device, such as a smartphone or tablet computing device and check-up on the sale team in real-time by accessing such a dashboard which retrieves the necessary data from the cloud (e.g., from the databases 155 of the host organization 110 at FIG. 1) on behalf of the sales manager. So long as the information has been updated into the cloud then the dashboard will retrieve and display the up-to-date information in real-time.

According to one embodiment, each of the opportunity stage overview 265 and the opportunity records 230 view constituting the depicted dashboard view are pluggable graphical elements selectable and configurable by the users themselves.

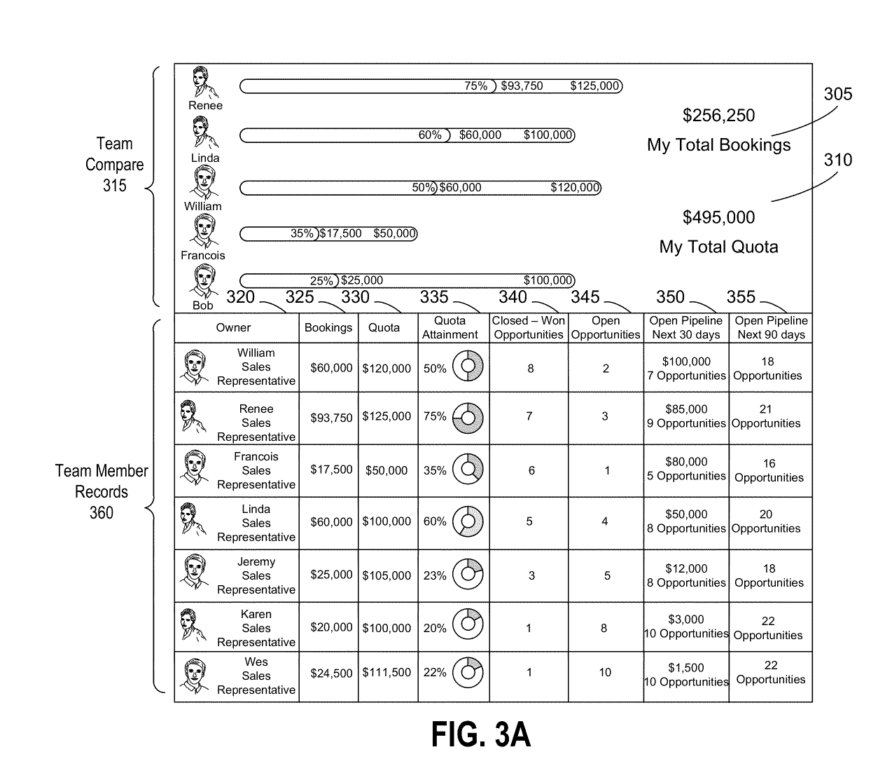

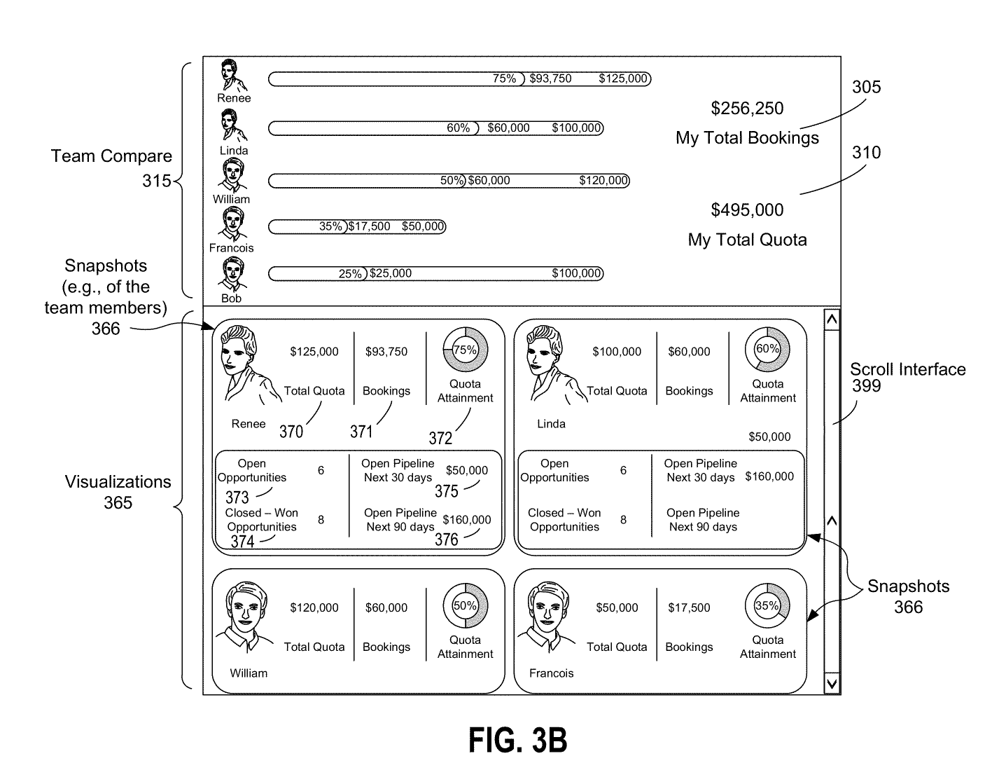

FIG. 3A depicts another exemplary graphical interface in accordance with the embodiments. In particular, another dashboard view is depicted which may be accessed by default, accessed directly, or navigated to by a user through another dashboard or via an appropriately configured graphical display.

This particular dashboard provides a listing of team member records 360 near the bottom along with pertinent data for each team member in the various columns showing for each displayed team member listed: the owner 320 (e.g., the team member), bookings 325, quota 330, quota attainment 335 per team member in both numeric and graphical form, closed—won opportunities 340 (e.g., a quantity count of successfully closed sales opportunities), open opportunities 345, open pipeline next 30 days 350 showing both amount and opportunity count and lastly open pipeline next 90 days 355. As with the prior dashboard, the team member records 360 may be presented in a scrollable view with further records able to be displayed responsive to a user scrolling or swiping action.

Further depicted is a team compare 315 view listing a subset of the sales team here (in what may also be a scrollable view) along with a bar graph per sales team member shown with bookings toward quota for each individual sales team member (e.g., Renee as depicted has reached 75% quota attainment for the relevant period with $93,750 booked toward her $125,000 quota). Lastly the dashboard view depicts total bookings for the user of the dashboard at element 305 (e.g., a sales manager operating as the user may have aggregate bookings of $256,250, as displayed in this example) and further depicted is the user's total quota for the period at element 310 (e.g., the sales manager as the user may have a quota of $495,000 for the period to be fulfilled.

According to one embodiment, each of the team compare 315 view and the team member records 360 view constituting the depicted dashboard view are pluggable graphical elements selectable and configurable by the users themselves. For instance, the various displays described herein, including the dashboard at FIG. 3A are customizable by the users by selecting which pluggable graphical elements the particular user wishes to include in a given dashboard from a population of such pluggable graphical elements made available for such a purpose. Parameters may further be customized, such as the relevant period or date range, what members constitute a sales team or a sub-group of such a team, and so forth.

FIG. 3B depicts another exemplary graphical interface in accordance with the embodiments. In this dashboard view the team compare 315 view remains the same with total bookings depicted at element 305 and total quota depicted at element 310. However, visualizations 365 has been introduced. Scroll interface 399 enables a user to manipulate the display by scrolling or swiping to additional team members' snapshots 366 making up the visualizations 365. Visualizations 365 may operate as a pluggable graphical element selectable and configurable by the users themselves for inclusion with a customized dashboard created by a user.

As depicted, snapshots 366 for Renee and Linda are fully displayed with William and Francois being partially covered. Nevertheless, within each team member's snapshot there are a series of display elements pulled or retrieved by the display's functionality from the cloud (e.g., by sourcing such data from the databases 155 of the host organization 110 in the manner described with regard to FIG. 1 above).

Turning to the snapshot 366 of Renee specifically, there is further depicted a total quota 370 for Renee, total bookings 371 for Renee, quota attainment 372 for Renee, an open opportunities count 373 for Renee, a closed—won opportunities count 374 for Renee, open pipeline next 30 days 375 for Renee, and lastly open pipeline next 90 days 376 for Renee. Each of the other displayed snapshots 366 display similar display elements but in the context of the particular sales team member displayed (e.g., team members Linda, William, and Francois being depicted here).

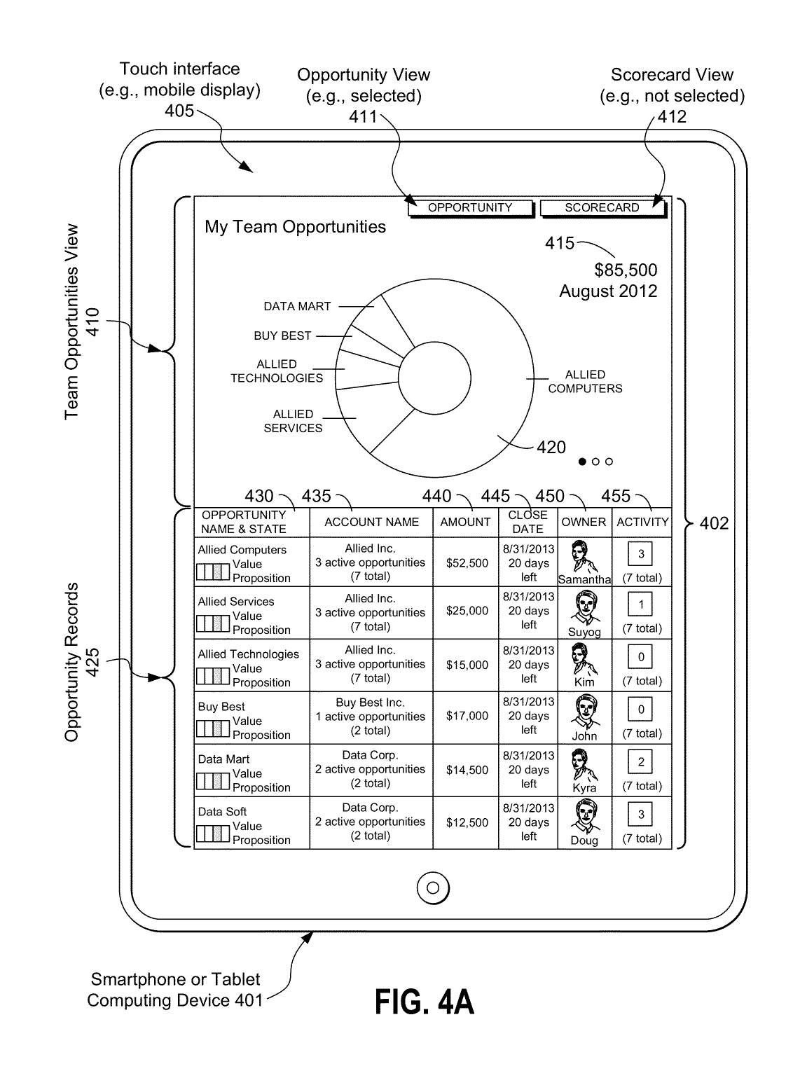

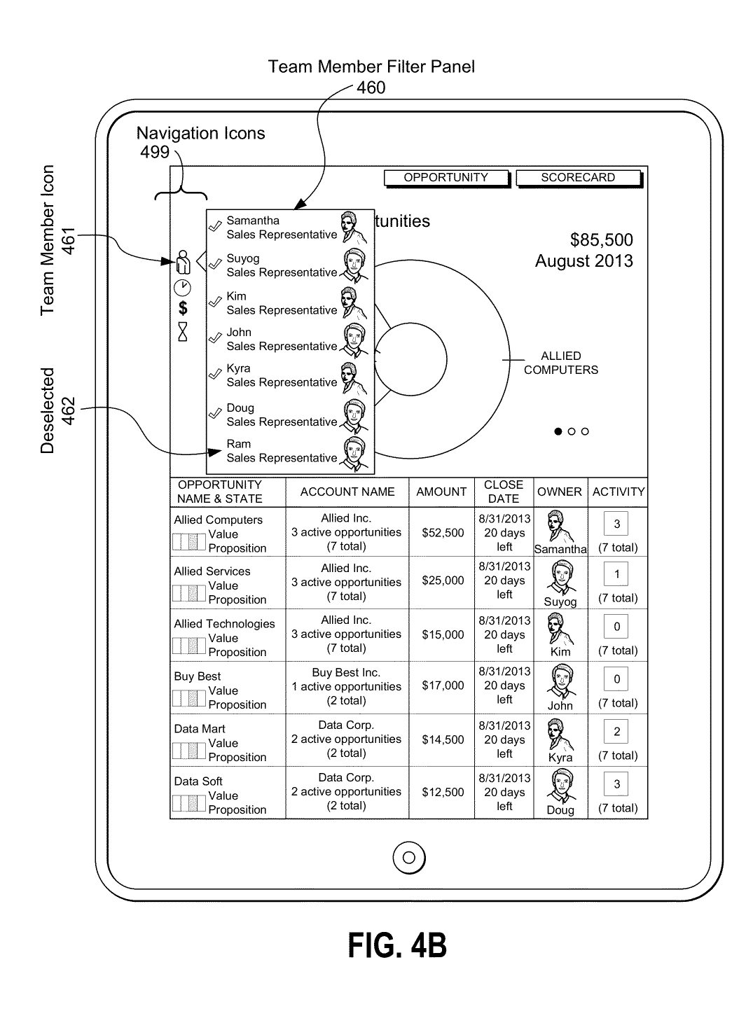

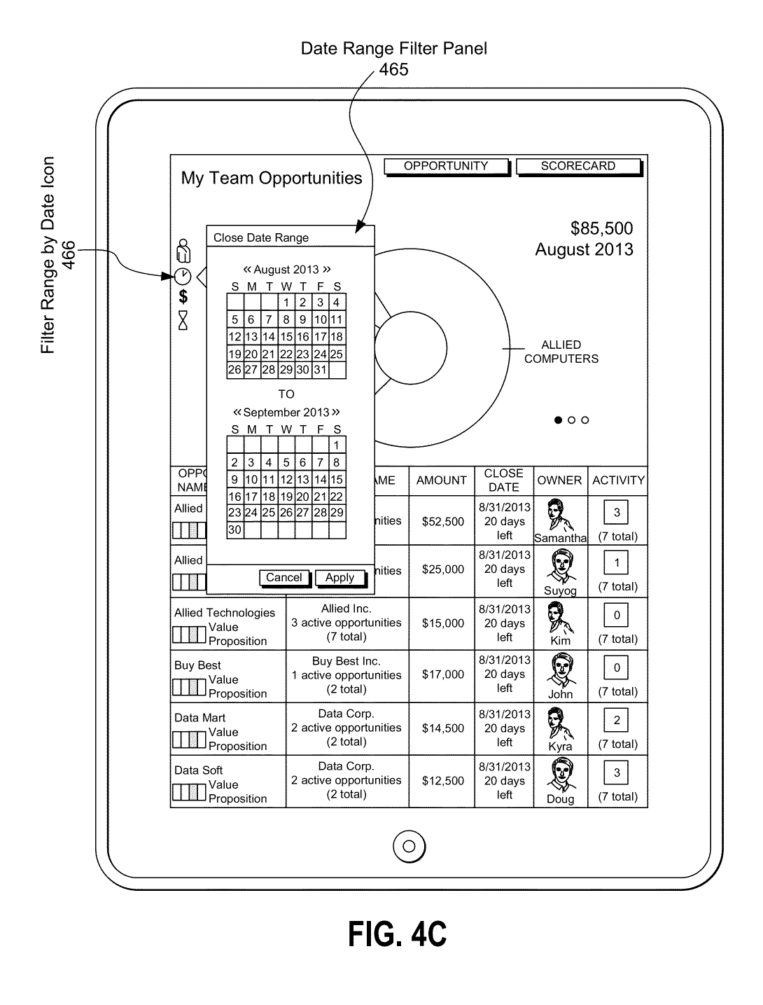

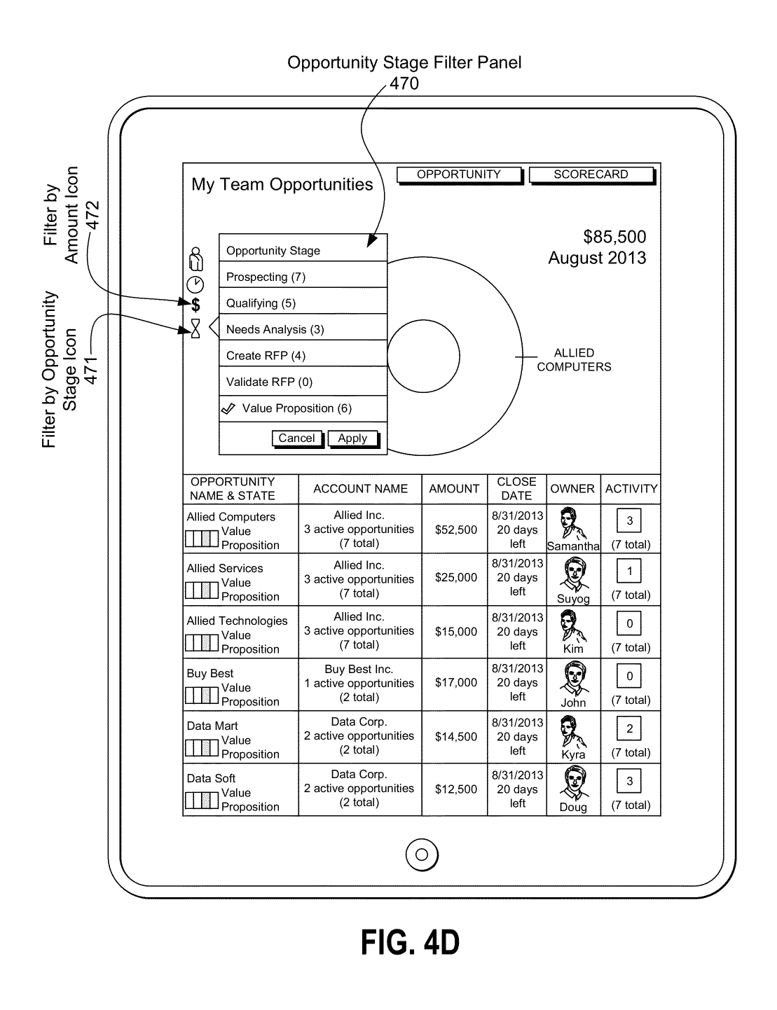

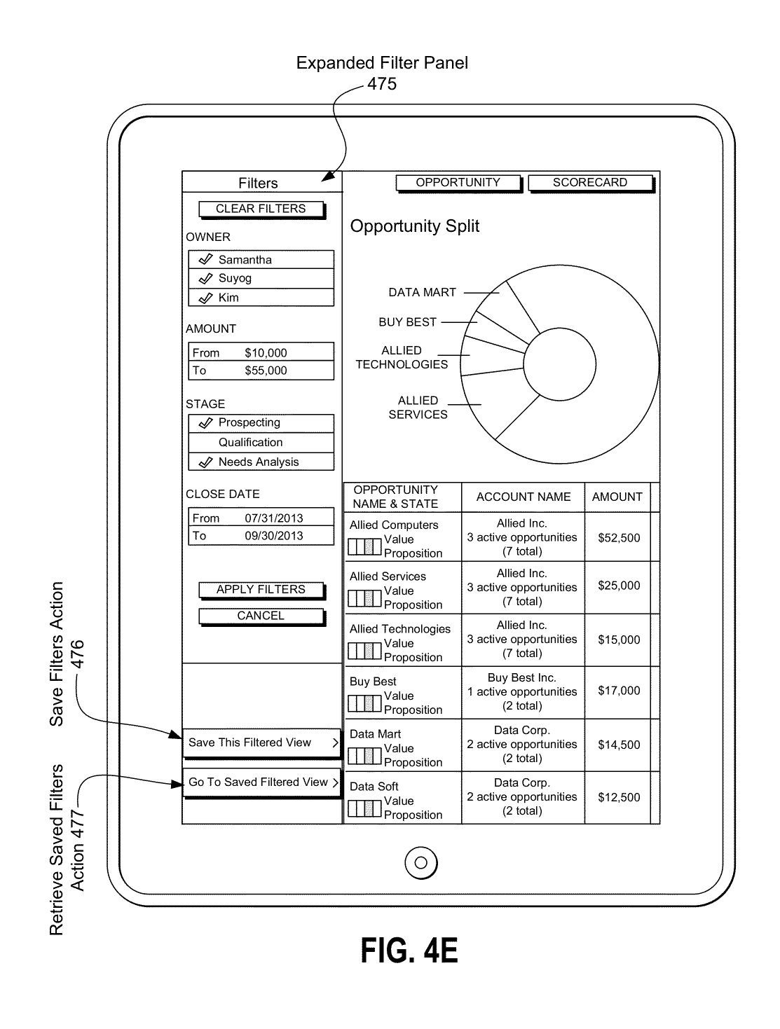

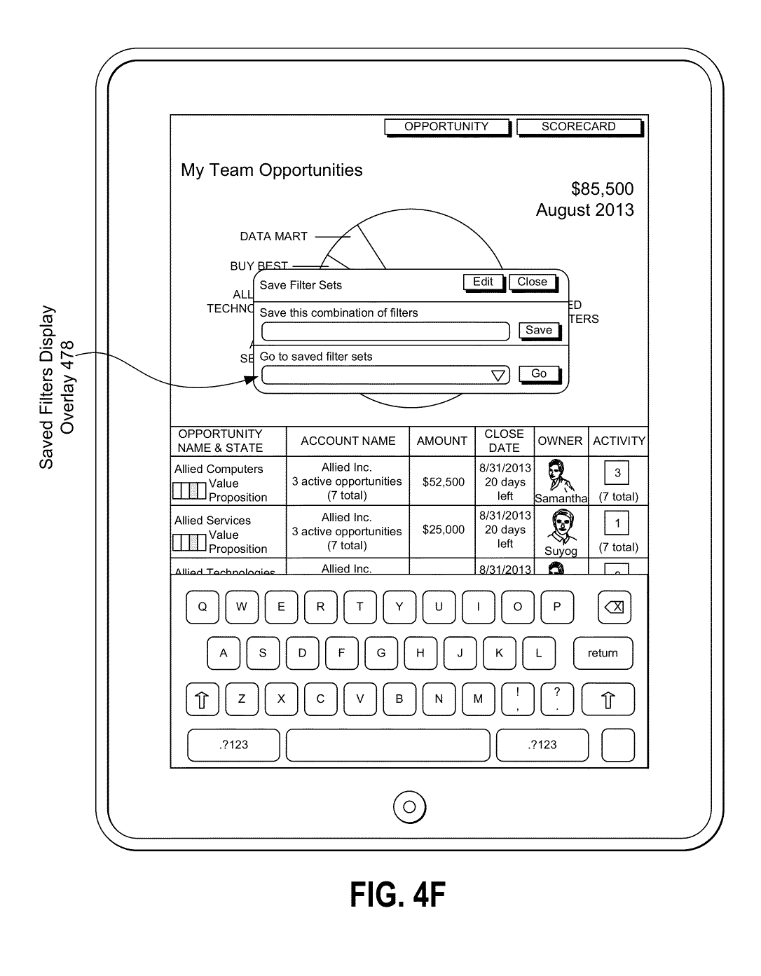

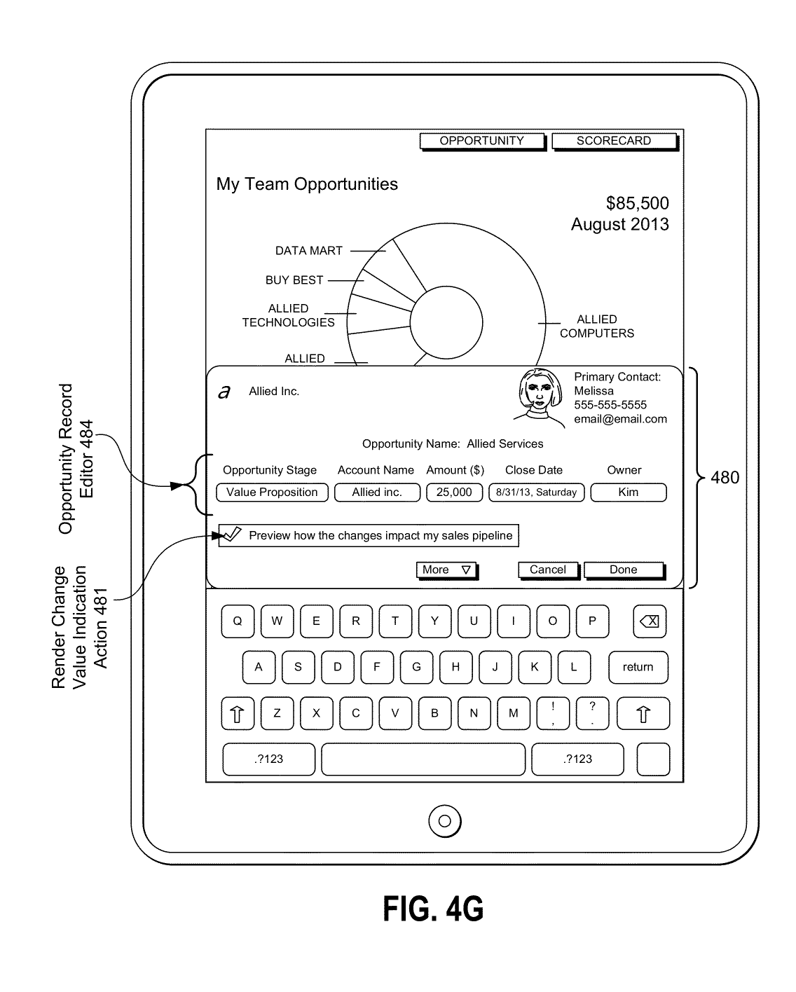

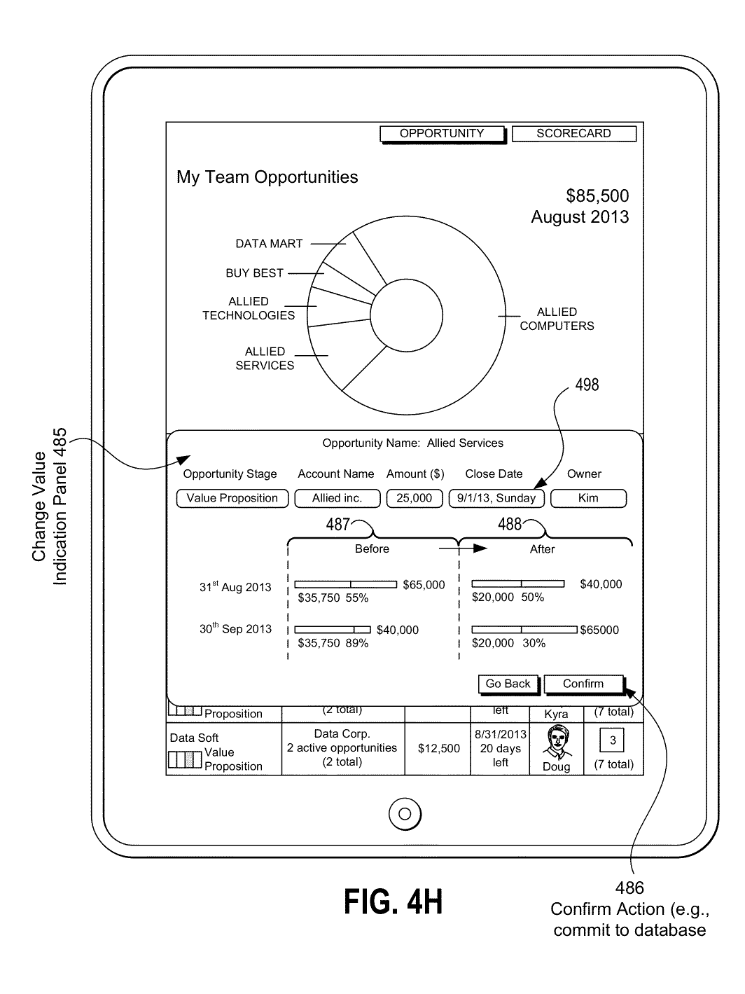

FIG. 4A depicts an exemplary graphical interface 402 operating at a mobile, smartphone, or tablet computing device in accordance with the embodiments. More particularly, there is depicted an exemplary smartphone or tablet computing device 401 within which a touch interface (e.g., mobile display) 405 operates to display the graphical interface 402.

Graphical interface 402 displayed at the smartphone or tablet computing device 401 includes both a team opportunities 410 view and an opportunities records 425 view, each of which may themselves operate as pluggable graphical elements selectable and configurable by the users themselves for inclusion with a customized graphical interface 402 view for a user.

At team opportunities 410 view there are included two navigation actions, shown here as an opportunity view 411 icon which is presently selected in the depicted view of the graphical interface 402 and scorecard view 412 icon which presently is not selected in the depicted view. Further shown within team opportunities 410 is a graphical chart at element 420 depicting the various sales opportunities by account name (e.g., Data Mart, Buy Best, Allied Technologies, etc.) with the depicted slices of the chart being in proportion to the size of the opportunity (e.g., by opportunity amount). Element 415 depicts the total opportunity amount represented at the depicted team opportunities 410 view for the pertinent month or period (e.g., shown here as “August 2013”) which may or may not be the present month or period. For example, the user may explore historical opportunities by day, week, month, quarter, year, etc., if such data is in the past, explore present opportunities where such data represents the present, and explore future potential opportunities where such data represents forecasting or predictive data (e.g., the interface may render recorded forecasting data or query for predictive results via, for example, a PreQL “PREDICT” command term call to queryable indices generated by the host organization based on observed data). PreQL is a Predictive Query Language structure observed by the host organization for receiving and responding to PreQL based command terms including, but not limited to: PREDICT, RELATED, GROUP, SIMILAR, UPLOAD, and ANALYZE.

On the bottom portion of the displayed graphical interface 402, the opportunity records 425 view depicts multiple such opportunity records, each with pertinent data shown by column, including: opportunity name and state 430, account name 435, amount 440, close date 445, owner 450, and activity 455. As in prior embodiments, components of the opportunity records 425 view may provide contextually appropriate navigation events when selected and the opportunity records 425 view itself may operate as a pluggable component.

Having a smartphone or tablet computing device 401 as depicted along with access to the graphical interface 402 depicted, a manager, user, or other such subscriber may quickly reference pertinent information and metrics about their current business opportunities and metrics, be they sales centric, or other business metrics commonly needed by such individuals.

Providing the relevant graphical interfaces in a mobile friendly and web-compliant manner enables sophisticated displays to be rendered at a mobile computing device such as the smartphone or tablet computing device 401 without requiring the mobile device to install any software, drivers, or libraries whatsoever locally to the device as the web-compliant displays can be rendered via an existing browser that comes pre-installed with such devices. Alternatively, as is common with mobile form factors including smartphones and tablets, a mobile application may be specially installed to perform the same functionality, but is not necessarily required. Moreover, while it is somewhat common to install special mobile applications to mobile devices, it is not at all desirable to require users of PCs and laptops to install any software, and as such, PC and laptop users are much more likely to leverage the web-compliant functionality which permits operation of the described features via the cloud (e.g., via the computing architecture of the host organization) without having to install software.

FIG. 4B depicts another exemplary graphical interface operating at a mobile, smartphone, or tablet computing device in accordance with the embodiments. More particularly, there is depicted a team member filter panel 460 overlaid upon the team opportunity view described previously. The team member filter panel 460 lists the various team members in the context of the user and permits one or more of them to be deselected 462. By deselecting a team member the contextually relevant metrics displayed at the graphical interface are updated to reflect the change, for instance, team member Ram is shown as having been deselected 462, and when the filtering action is applied, any sales opportunities associated with him as the owner will be removed from the view. The same concept is equally applicable to other views, for instance, where sales opportunity amounts are displayed at the graphical interface, deselecting Ram would cause his contributions to be removed from the applicable charts and information display elements.

In this particular embodiment, the team member filter panel 460 was accessed or navigated to via the navigation icons 499 shown by a user selecting, touching, or clicking the team member icon 461 shown, in the context of the depicted view (the team opportunities view 410 described at FIG. 4A and still partially visible beneath the filter overlay) presented the team member filter panel 460 overlay. Filter navigation enabled via the contextually relevant navigation icons 499 operates based on context or perspective of an underlying object presenting the requisite display logic for the given view at the graphical interface.

For instance, where a user is viewing opportunity records and deselects a salesperson, the underlying objects relates the deselection of the salesperson to the context of the information displayed, specifically, if a salesperson is no longer to be included then by extension, that salesperson's sales opportunities should not be displayed. Additional analytics may also be applied in the context of the filtering, depending on the information presently displayed and will be driven by the display logic of the underlying object providing the view to the graphical interface.

Other navigation options 499 permissibly displayed include, for example, activity icons permitting users to navigate to a particular activity number within a table or to other interfaces available through the cloud services of the host organization, such as Chatter™ by salesforce.com, etc.

The information of the depicted graphical interface is manipulatable in a variety of ways through the filtering mechanism. For example, a manager may use an appropriate filters panel to alter close dates for inclusion, such that only close dates on a specified filter date or within a specified filter date range appear within the informational display of the graphical interface.

In a particular embodiment, and apply and cancel buttons are wholly removed from the filter panels such that selecting or deselecting an element (e.g., such as deselecting team member Ram as shown here) automatically takes effect at the graphical interface. In another embodiment, selections at the various filter panels are effected when a user clicks or touches anywhere outside of the respective filter panel, such as within a view upon which the filter panel is overlaid. In other embodiments, apply and cancel action elements are used, for instance, as is depicted in the following FIG. 4C showing a date range filter panel.

FIG. 4C depicts another exemplary graphical interface operating at a mobile, smartphone, or tablet computing device in accordance with the embodiments. Depicted here is a date range filter panel 465 within which a user may specify a date or a date range. As noted previously, cancel and apply buttons are used in this particular embodiment but are not necessarily required. The date range filter panel 465 may be accessed by selecting, touching, or clicking the filter range by date icon 466 in the context of the appropriate graphical interface view as shown.

Users may filter the informational displays using more than just a single filter panel. For instance, the date range filter panel 465 may be used to specify an appropriate date range and separately the team member filter panel 460 may be utilized to select which of the available team members are to be represented within the informational display. Other filter panels are additionally described and may likewise be used individually or in combination with others to affect the displayed content.

Application of filter panels may be applied locally via display logic at the smartphone or tablet computing device 401 which is extremely fast because there is no need to re-request data from the cloud to secure the revised dataset. For instance, a broadest list view or broadest dataset may be retrieved initially and cached subsequent to which applied filters then yield local derivatives of the cached dataset, such as a filtered sub-set.

In alternative embodiments it may be necessary to apply the filters remotely in the cloud by the host organization (e.g., via analysis engine 185 at FIG. 1, etc.) pursuant to which the graphical interface is refreshed with the appropriate view if, for example, the necessary data set is not cached or the computational load to perform required filtering and analytics is excessive. The location for computation, filtering, or other such analysis depends largely upon the computational load required to render the change in view or the accessibility or lack thereof to such data. For example, where a filter requires more than modest computation, it may be preferable to not burden the smartphone or tablet computing device 401 which may have only limited computational resources. Conversely, simple filtering may be applied wholly locally, assuming the smartphone or tablet computing device 401 possesses the necessary dataset from a prior exchange with the host organization's cloud services. Assuming data is locally cached, local filtering will likely result in greater efficiency and responsiveness.

FIG. 4D depicts another exemplary graphical interface operating at a mobile, smartphone, or tablet computing device in accordance with the embodiments. In particular, there is depicted an opportunity stage filter panel 470 contextually accessible via the filter by stage opportunity icon 471. The opportunity stage filter panel 470 permits for the selection or deselection of one or more available opportunity stages, in which deselecting one of the stages will affect the informational display at the graphical interface such that the deselected stage no longer is taken into account within the information displayed, thus, it is filtered out.

The filter by amount icon 472 is additionally depicted here and accesses an amount filter panel which is not shown, but is otherwise consistent with the other filter panels described and depicted. Filter by amount fields from the underlying object providing the amount filter panel are depicted, however, in the expanded filter panel of FIG. 4E that follows.

FIG. 4E depicts another exemplary graphical interface operating at a mobile, smartphone, or tablet computing device in accordance with the embodiments. In particular, the expanded filter panel 475 is depicted which incorporates into a single filter view the relevant filter actions, selections, and inputs from a variety of available filter panels. For instance, the expanded filter panel 475 shown here includes a clear filters action to default or delete any input, and further includes filter by owner toggles, filter by amount input fields, filter by stage toggles, filter by close date range selectors, and then apply and cancel actions to either apply or cancel the user's selections and inputs.

Additional filter actions are depicted within the expanded filter panel 475 enabling a user to either save the selected filter toggles, inputs, and selections, by clicking the save filters action 476 or to alternatively retrieve previously saved toggles, inputs, and selections by clicking the retrieve saved filters action 477. For example, a user may have a favorite set or multiple commonly utilized filter sets and the retrieve saved filters action 477 enables such a user to quickly and easily retrieve them.

Take for example a user wishing to view only opportunities over $100K. The expanded filter panel 475 permits such a user to quickly input the pertinent values, be they for amount or for other metrics, and then adapt the informational display immediately without having to got to a reports development team, request the applicable report parameters, wait for the creation of the report utility, and then run the appropriate report. What feasibly could have taken weeks using conventional solutions can be attained in moments through the described functionality. Consider for example a manager or sales person in a sales meeting discussing opportunities, targets, quotas, and so forth. Questions about such metrics can be nearly instantly answered by quickly applying the appropriate filters in a highly intuitive manner.

Metrics are filterable in the context of the user, and as such, a user having access rights to additional data and metrics will have additional corresponding filters. A user with access rights to fewer metrics cannot filter against what they cannot access, and as such, will have fewer filters.

According to certain embodiments, users can share their saved filters with others, such as with their sales manager or with other sales persons, etc.

FIG. 4F depicts another exemplary graphical interface operating at a mobile, smartphone, or tablet computing device in accordance with the embodiments. In particular, a saved filters display overlay 478 is depicted having actions to either save a presently applied set of filters (for instance, if the user applies filters from individual filter panels or via the expanded filter panel but does not save them) or to alternatively retrieve and apply a previously saved set of filters from a dropdown and clicking the go action button. If saving a previously applied set, the user may enter a filter name for the filter set to be saved and then click the save action button.

In one embodiment a user may designate a saved filter set as a default view. In another embodiment, such users may create multiple distinct saved filter sets, such as one for each sub-group of salespersons within a sales team; one for each individual salesperson on a team, one for different classes of sales opportunities (e.g., such as $500,000 plus opportunities as a group and sub-$500,000 opportunities as a second group), and so forth. When ever a business person finds themselves crafting a particular set of filters with regularity, they will benefit from creating a saved filter set in the manner described.

FIG. 4G depicts another exemplary graphical interface operating at a mobile, smartphone, or tablet computing device in accordance with the embodiments. More particularly, there is depicted a record modifier panel 480 view overlaid upon the team opportunities view at the graphical interface. Within the record modifier panel 480 view are opportunity record editor 484 and a render change value indication action 481 which toggles using the checkmark as depicted.

With conventional solutions, it is not possible to edit underlying database records from a previously run report due to the stand alone nature of conventional business intelligence reporting objects used to access data from their source database. Conversely, the mechanisms described herein are able to pull pertinent data from the cloud (e.g., from the databases 155 of a host organization's 110 multi-tenant database system 130 as depicted at FIG. 1) for display but additionally enable a write-back interface such that a user interacting with the graphical interface and more particularly with the record modifier panel 480 view depicted here is able to specify a record for modification at the graphical interface (e.g., by clicking, touching, selecting an edit icon, or via a long-hold action according to certain embodiments) which will then render the record modifier panel 480 view depicting the particular record selected for editing by populating the opportunity record editor 484 with the present values of the underlying record stored in the database. Using text boxes, dropdowns, selectors, and other user interface input fields, the user of the graphical interface can then modify the records at the record modifier panel 480 view displayed at a graphical interface and then select the done action button as depicted to save and commit the modified record to the underlying records of the database.

In an alternative embodiment, the user may wish to first view how the proposed change will alter the informational displays which will be affected by the record change, and in such a case, the user may select or toggle on the option to “preview how the changes will affect” the particular record being edited by selecting the render change value indication action 481.

Using this action allows the user to explore what-if situations or preview the proposed change in a predictive manner without committing the change to the underlying records of the database. As such, other reports and other users pulling from the same underlying records of the database will not be affected by the proposed change until the modified record is actually committed to the database.

In conventional solutions, it would be necessary to access an alternative interface which allows for record editing, modify the record, commit the record to the database, and then re-run the original report or reports to view how the modified record affected the relevant reports. For example, even of all the interfaces were available through a web-display, there would be a lot of clicking and navigation for the user making the task complex as the user would have to identify the appropriate interface, open it, then search for and find the appropriate record to be edited (rather than simply long clicking or selecting it as is the case in with the embodiments described here), commit and then re-run the reports as noted above, by again, navigating to different interfaces once again. Use of the embodiments described herein allows the user to remain on the same page (e.g., within the team opportunities view or within the same graphical interface), select a record to be edited without having to search for it separately, and then simply make the desired change through the overlay view provided via the record modifier panel 480 view. Such a methodology is even more beneficial when using a tablet, smartphone, or other mobile computing device with very limited screen real estate.

Worse yet, the conventional solutions simply do not offer “what-if” exploration capabilities. Instead, conventional solutions required a proposed modification to be committed to the source with what may be erroneous information. Thus, if a record changed and committed through conventional means was not correctly modified or not appropriate, then committing it to the database will cause other reports, users, metrics, statistics, and anything else which pulls from the same source to then render erroneous information due to the proposed modification that should not have been committed to the database.

Using the render change value indication action 481 the user can see how a proposed change affects the relevant reports and metrics for their organization, quotas, sales team, etc. Consider for example a conversation between a salesperson and their manager with regard to a particular sales opportunity that will not close in the present month, as was previously expected. The salesperson can, from the displayed report, select the record for modification, make the edit to the sales close date, and then either commit the change or use the render change value indication action 481 to predictively view how the change affects the report. Once satisfied, the user can then commit the change to the database or cancel the modification using the displayed cancel action.

The render change value indication action 481 may operate in various ways. Where a full dataset is cached at a local device, the graphical interface can modify the local cache copy and re-render the updated view affected by the change. If a full dataset is not cached, the data may be pulled from the cloud, edited locally for the affected record, and then the local device may re-render the updated view affected by the change. The transactional nature of the multi-tenant database system (e.g. element 130 and/or databases 155 at FIG. 1) may also be leveraged by saving but not committing the modified record to the multi-tenant database, then re-running the report. Once satisfied, the user may commit the modified record to the database by clicking the done action button or may cancel the modification by clicking the cancel action button which in turn causes the modification to be rolled back at the multi-tenant database system. If the report was run using a conventional business intelligence reporting object then a write back would not be possible because such objects are by design read-only.

FIG. 4H depicts another exemplary graphical interface operating at a mobile, smartphone, or tablet computing device in accordance with the embodiments. More particularly, a change value indication panel 485 view is depicted which is rendered to the user responsive to selecting the render change value indication action 481 at FIG. 4G.

Noted previously, when the user selects the render change value indication action 481 at FIG. 4G the modification is not committed to the database, and as such, the user now has the option at the change value indication panel 485 view to either cancel the proposed record modification by selecting the go back action button as depicted here (or a cancel action button, etc.) or the user may now commit the proposed record modification by selecting the confirm action 486 button as depicted here to formally commit the record modification to the database (or by clicking a “save” action button, or equivalent).

Further depicted at the change value indication panel 485 view is a “before” 487 state view and an “after” 488 state view giving the user a quick glimpse of how the proposed record modification affects the relevant metrics in the context from which the user selected or initiated the record modification. For instance, as can be seen here, modifying the close date of Aug. 31, 2013, Saturday in the close date input field to Sep. 1, 13, Sunday as indicated at element 498 has caused the revenue for this opportunity record to shift the $25,000 amount for the sales opportunity out of the period ending Aug. 31, 2013 which was at $65,000 in the “before” view at element 487 (now showing $20,000 in the “after” view at element 488) and into the period ending Sep. 30, 2013 which was at $40,000 in the “before” view at element 487 (now showing $65,000 in the “after” view at element 488).

The user can consider this revised information and then either commit or not commit the record modification to the database as appropriate.

Making the edit in such a way and previewing the affected metrics through the change value indication panel 485 further helps to prevent erroneous record edits being introduced into the underlying records of the database.

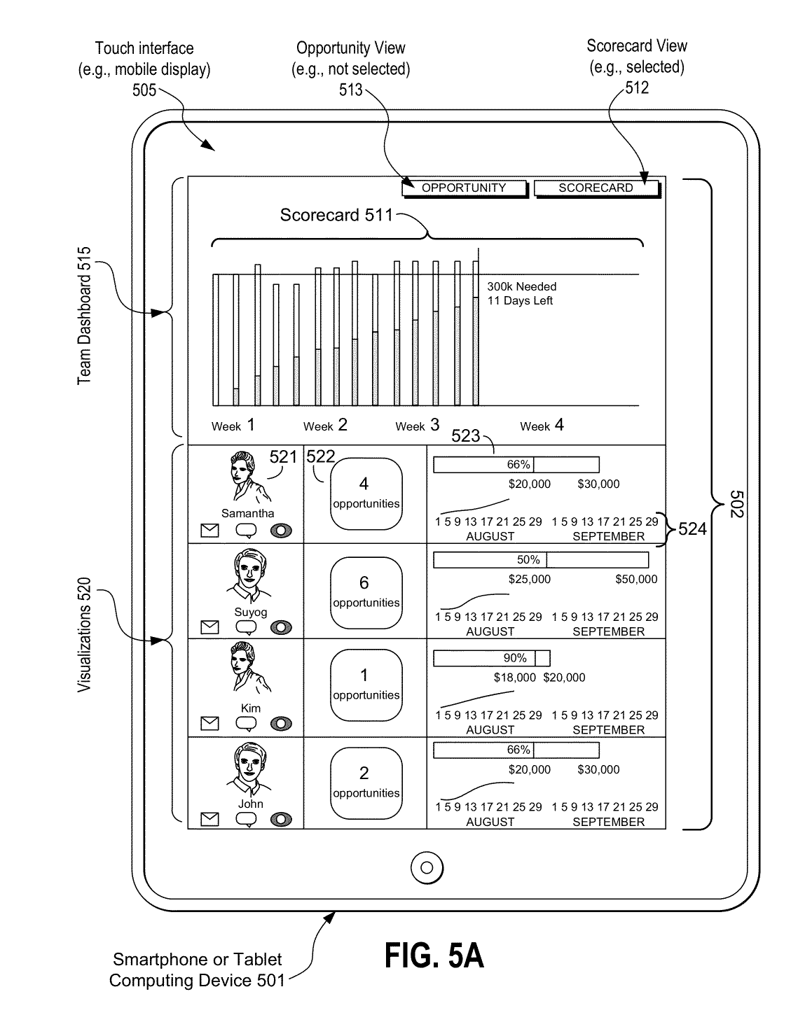

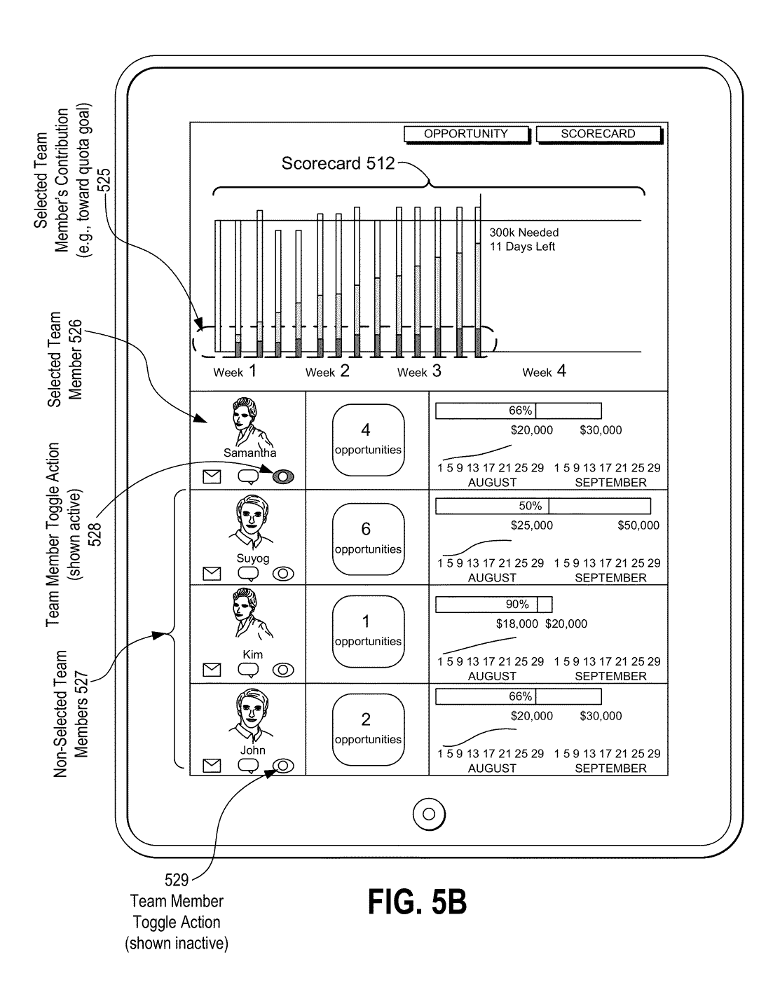

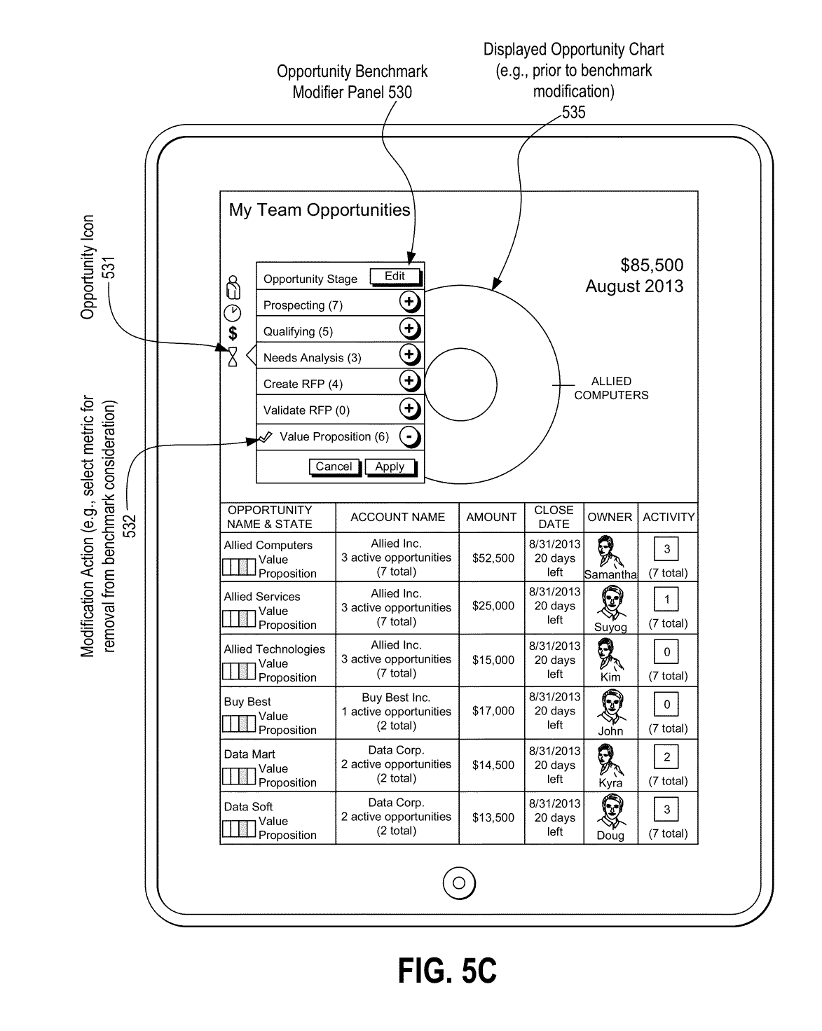

FIG. 5A depicts another exemplary graphical interface operating at a mobile, smartphone, or tablet computing device in accordance with the embodiments. More particularly, the scorecard view 512 selected here enables a manager or other supervisor to create a custom scorecard for their salespeople or other subordinates. Opportunity view 513 is presently not selected in this depiction.

The smartphone or tablet computing device 501 depicted here provides a touch interface (e.g., mobile display) 505 upon which a graphical interface 502 is displayed to a user of such a device. The graphical interface 502 displayed at the smartphone or tablet computing device 501 includes both a team dashboard 515 view and a visualizations 520 view, each of which may themselves operate as pluggable graphical elements selectable and configurable by the users themselves for inclusion with a customized graphical interface 502 view for a user, for instance, within a customized scorecard 512 view as is presently selected in the depiction here.

Visualizations 520 depicts the various team member records, each having several additional data elements therein provided via the columns, including: team member's name and image at element 521, opportunities count at element 522, quota attainment both graphically and numerically at element 523, and a line chart graphed over a calendar period (e.g., such as a quota period, month, quarter, bi-month, etc.) at element 524. Other or different elements may be included at the user's discretion by customizing and configuring the pluggable graphical element corresponding to this visualization 520 view.

Within visualization 520 view, each of the team members are presently active as indicated by the shaded eye shaped icon under each salesperson's name and image (e.g., see team member Samantha at element 521) and correspondingly, the scorecard 511 chart depicted here provides an overview of the team members selected. In this instance, the scorecard 511 chart reflects quota attainment for all of the team members shown as all are presently selected, which may be, for example, a default view.

FIG. 5B depicts another exemplary graphical interface operating at a mobile, smartphone, or tablet computing device in accordance with the embodiments. More particularly, the corresponding benchmark for scorecard 512 view has been modified by deselecting some of the team members. The team member toggle action 529 shows the bottom team member (John) as inactive and the team member toggle action at element 528 shows the top team member (Samantha) as active. In this particular view, Samantha is thus the only selected team member 526 leaving the non-selected team members 527 as inactive having all been toggled off, and thus, removing them from the customized benchmark depicted at the modified scorecard 512.

The selected team member 526 (Samantha) now is set apart in terms of her contribution to quota attainment in the modified scorecard 512 view within which the bottom portion of each of the bars with the darker shading show the selected team member's contribution 525 toward to quota goal within or overlaid upon the overall team's quota goal depicted via the lighter shading in the middle portion of each bar. More than one team member can be selected, for instance, a sales sub-group or partners for a particular account, and so forth.

In such a way, sales manager can select individual users and see what their contributions are to the overall team scores (whether that be dollars toward quota or other metrics such as closed wins, etc.) represented by the scorecard 512. Additionally, the scorecard 512 itself may be based upon an individual user, teams, sub-teams, accounts, or other appropriate metrics.

FIG. 5C depicts another exemplary graphical interface operating at a mobile, smartphone, or tablet computing device in accordance with the embodiments. More particularly, there are depicted here various navigational icons including opportunity icon 531 which, when selected, renders the opportunity benchmark modifier panel 530 which permits a user to select a metric for inclusion or removal from benchmark consideration used in creating the scorecards 511 and 512 depicted previously. Toggling or altering the various the modification actions 532 permits the user to customize the benchmark and then selecting the apply action commits the change to the benchmark displayed or other informational display rendered to the device as contextually appropriate.

For instance, the displayed opportunity chart 535 is depicted here prior to modification via the opportunity benchmark modifier panel 530 and after the user applies any changes made using the various the modification actions 532 the displayed opportunity chart 535 will be updated appropriately. For example, additional filters and modifications may be applied through the benchmark modifier panel 530 as shown by clicking the “Edit” action button, making the desired changes, and then applying them. One such change may be to add or remove a certain sales opportunity at different stages based on the needs of the salesperson, team, or sales manager, etc.

Allowing for the creation of customized scorecards enables the individuals or their supervisors to better evaluate effectiveness of a given individual, team, sub-group, entity, etc., based on a custom defined benchmark. Further still, the benchmark can be rendered in view of historical data where a specified period is in the past, rendered in view of current data for a present period, or rendered into the future using forecasting or predictive data provided by or stored within the cloud (e.g., within the multi-tenant database system 130 of the host organization 110 at FIG. 1). The affected scorecards subjected to the customized benchmarks further enable a user to alter the informational displays to explore various what-if scenarios without having to commit data to the database (e.g., such as removing record rows in order to negate a sales-person's contribution to a benchmark, and so forth).

Again, such a means enables the users to explore and interact with their data in a highly intuitive manner which lowers the complexity and learning curve associated with gaining access to such information and therefore increases the efficiency of the individuals making use of them.

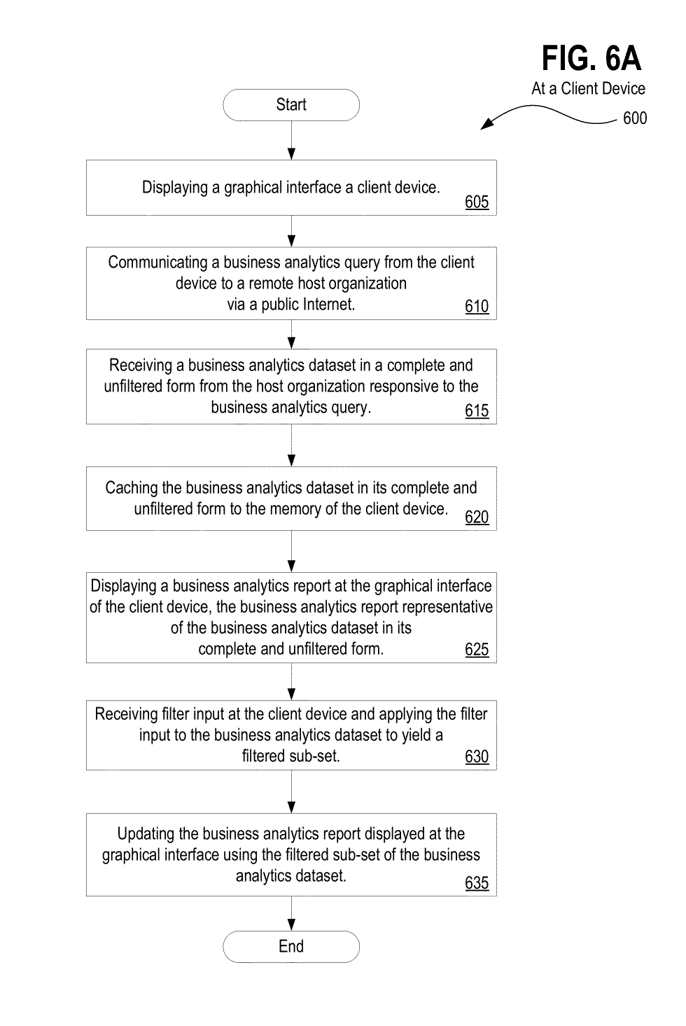

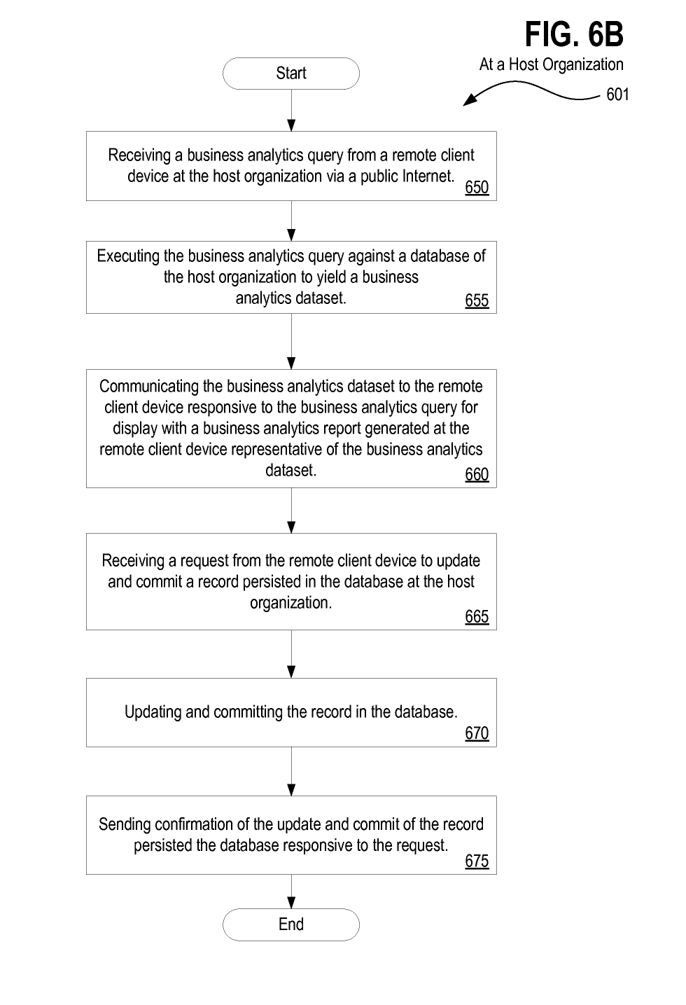

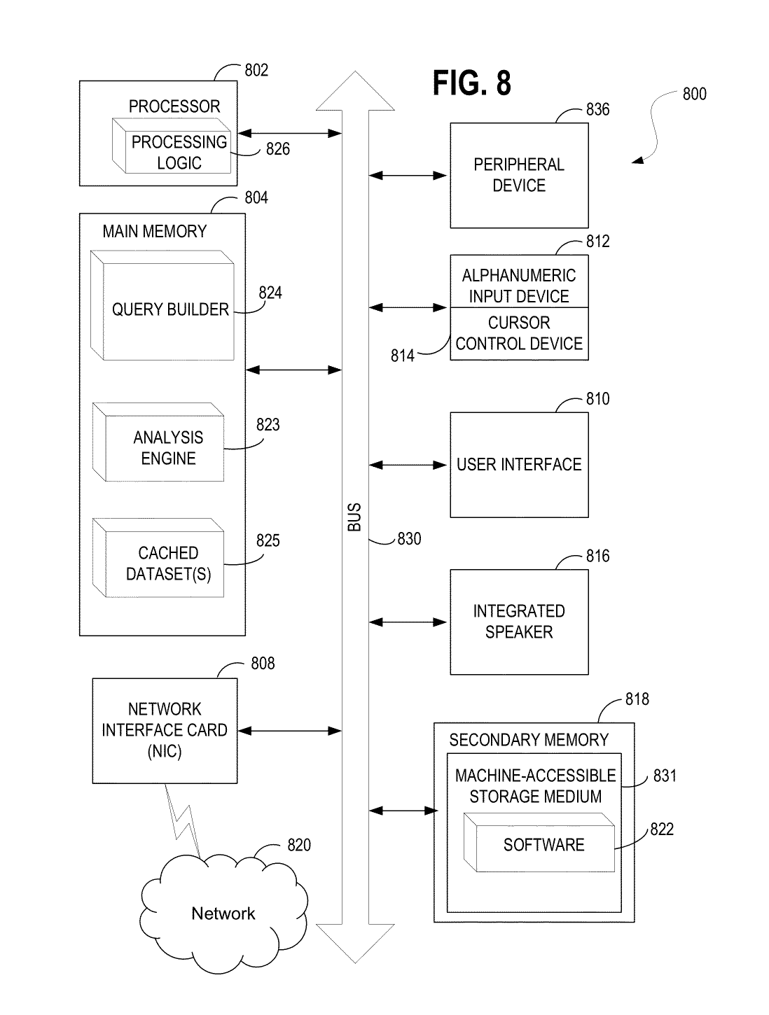

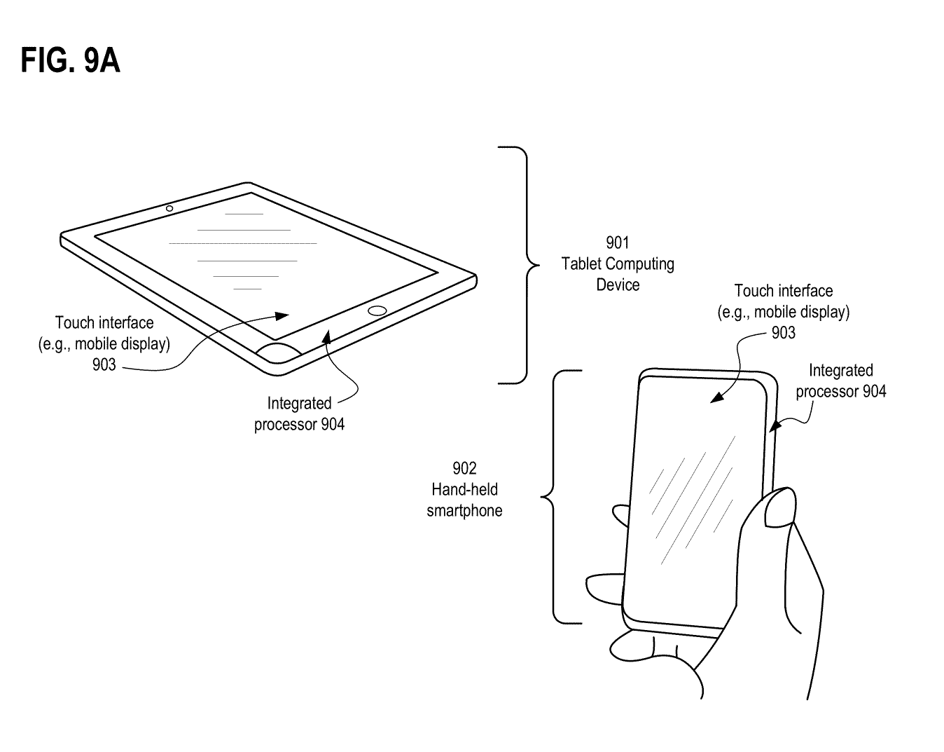

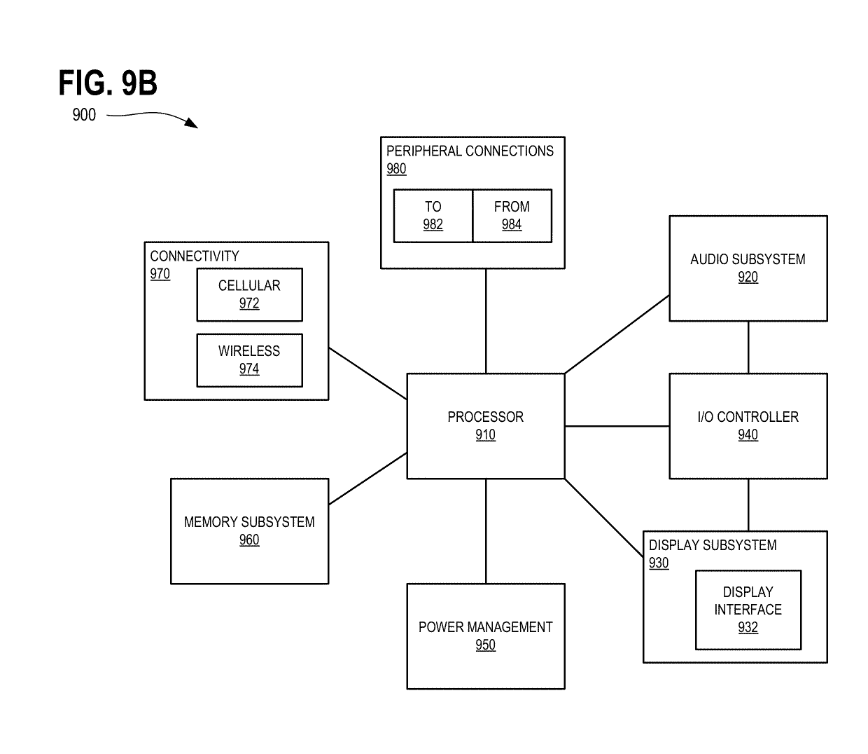

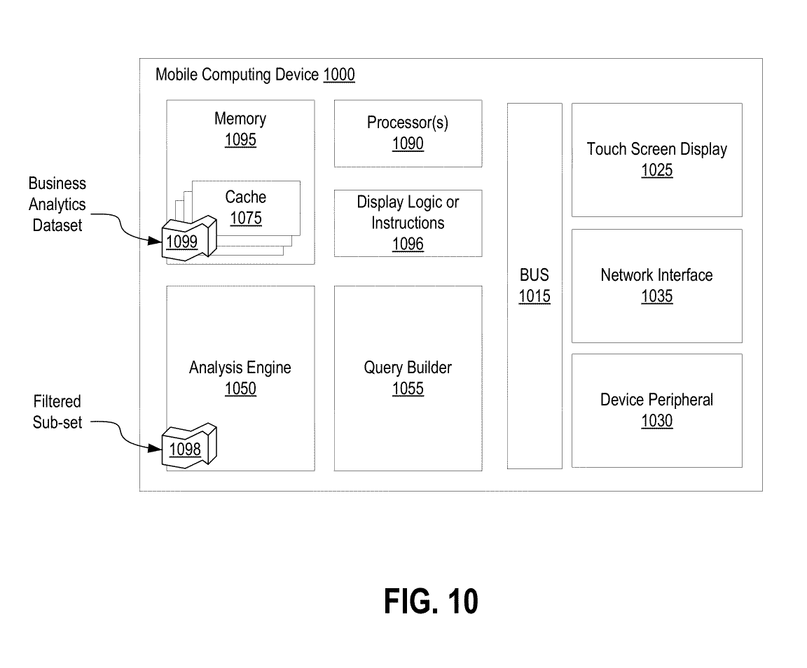

FIG. 6A is a flow diagram illustrating a method 600 at a client device in accordance with disclosed embodiments. FIG. 6B is a flow diagram illustrating a method 601 at a host organization in accordance with disclosed embodiments. Methods 600 and 601 may be performed by processing logic that may include hardware (e.g., circuitry, dedicated logic, programmable logic, microcode, etc.), software (e.g., instructions run on a processing device to perform various operations such as displaying, communicating, receiving, caching, updating, applying, filtering, committing, querying, executing, generating, capturing, exposing, transmitting, sending, etc., in pursuance of the systems, apparatuses, and methods for displaying and filtering business analytics data stored in the cloud, as described herein. For example, the computing architecture (e.g., within production environment 111) of host organization 110 as depicted at FIG. 1, machine 800 at FIG. 8, the tablet computing device 901 or hand-held smartphone 902 at FIG. 9, or the mobile computing device 1000 at FIG. 10, may implement the described methodologies. Some of the blocks and/or operations listed below are optional in accordance with certain embodiments. The numbering of the blocks presented is for the sake of clarity and is not intended to prescribe an order of operations in which the various blocks must occur.

With reference to FIG. 6A and method 600 at the client device, processing logic displays a graphical interface at the client device (block 605).

At block 610, processing logic communicates a business analytics query from the client device to a remote host organization via a public Internet.

At block 615, processing logic receives a business analytics dataset in a complete and unfiltered form from the host organization responsive to the business analytics query.

At block 620, processing logic caches the business analytics dataset in its complete and unfiltered form to the memory of the client device.

At block 625, processing logic displays a business analytics report at the graphical interface of the client device, the business analytics report representative of the business analytics dataset in its complete and unfiltered form.

At block 630, processing logic receives filter input at the client device and applies the filter input to the business analytics dataset to yield a filtered sub-set.

At block 635, processing logic updates the business analytics report displayed at the graphical interface using the filtered sub-set of the business analytics dataset.

According to another embodiment of method 600, updating the business analytics report displayed at the graphical interface comprises generating the updated business analytics report without a second business analytics query from the client device to the remote host organization.

According to another embodiment, method 600 further includes: receiving new filter input at the client device; applying the new filter input to the business analytics dataset in its complete and unfiltered form to yield a second filtered sub-set different than the first filtered sub-set, in which the second filtered sub-set is generated from the cache of the client device having the business analytics dataset in its complete and unfiltered form stored therein; and updating the business analytics report displayed at the graphical interface using the second filtered sub-set of the business analytics dataset.

According to another embodiment of method 600, displaying a business analytics report at the graphical interface of the client device, includes: displaying at least a scrollable list view at the graphical interface of the client device having a quantity of records equal in number to a quantity of records within the business analytics dataset in its complete and unfiltered form; and in which any records of the scrollable list view which exceed a display range of the client device are displayable within the scrollable list view displayed via a scroll interface of the graphical interface responsive to user input.

According to another embodiment of method 600, displaying a business analytics report at the graphical interface of the client device, includes: displaying a dashboard view at the graphical interface of the client device, in which the dashboard view includes at least: (i) a quantity of records equal in number to a quantity of records within the business analytics dataset in its complete and unfiltered form rendered via a scrollable list view; and (ii) a plurality of business metrics rendered in graphical and numeric form having been calculated from the business analytics dataset in its complete and unfiltered form.

According to another embodiment of method 600, the quantity of records of the dashboard view includes a listing of all sales opportunity records present within the business analytics dataset in its complete and unfiltered form; and in which the plurality of business metrics rendered to the dashboard view includes a total sales quota attainment for a period in numeric form and as a graphical pie chart.

According to another embodiment, method 600 further includes: authenticating a user of the client device with the host organization as a known subscriber; generating the business analytics query based on a context of the known subscriber; and in which the business analytics dataset in its complete and unfiltered form corresponds in scope to the context of the known subscriber.

According to another embodiment of method 600, the context of the known subscriber is selected from the group including: an individual salesperson having no subordinates, in which the business analytics dataset includes a plurality of records associated with the individual salesperson; a sales manager having as subordinates a sales team of multiple individual salespersons, in which the business analytics dataset includes a plurality of records associated with the multiple individual salespersons; and a business executive having as subordinates, multiple sales managers, each having one or more sales teams of multiple individual salespersons, in which the business analytics dataset includes a plurality of records associated with the multiple sales teams.

According to another embodiment, method 600 further includes: receiving user selection input at a graphical element of the business analytics report displayed at the graphical interface; generating a new view for display to the graphical interface based on a context of the graphical element corresponding to the selection input, in which the new view includes a sub-set of the business analytics dataset restricted according to the context; and displaying the new view to the graphical interface.

According to another embodiment of method 600, the graphical element corresponds to one of: a navigational icon displayed at the graphical interface; a record displayed at the graphical interface; a field of a record displayed at the graphical interface; a business metric displayed in numeric form at the graphical interface; and a business metric displayed in graphical form at the graphical interface.

According to another embodiment of method 600, the new view is selected from the group including: (i) an opportunity stage overview having therein a plurality of sales opportunity stages represented by the business analytics dataset with sales opportunity amount numerically depicted per sales opportunity stage; (ii) a total quota overview for a sales team depicting total quota for the sales team and total quota attainment for the sales team; (iii) an opportunity records view having therein a plurality of opportunity records displayed with at least an account name, an account owner, and a sales opportunity amount per opportunity record; (iv) a team compare view having therein total bookings against total quota for a sales team and quota attainment toward goal per sales individual of the sales team; (v) a team member records view having therein a plurality of individual salespersons records displayed with at least a salesperson name, a salesperson quota, and a salesperson quota attainment per individual salespersons record; (vi) a visualizations view having therein a plurality of snapshots corresponding to multiple individual salespersons records of a sales team, each snapshot including at least a salespersons image or likeness, a salesperson name, a salesperson quota, and a salesperson quota attainment per individual salespersons record; and (vii) a team opportunities view having displayed therein at least a graphical pie chart graphing multiple sales opportunities represented within the business analytics dataset, each of the multiple sales opportunities graphic in visual proportion of sales amount per sales opportunity to a total sales opportunities amount for the multiple sales opportunities graphed.

According to another embodiment of method 600, the new view is selected from the group including: (i) a team member filter panel view overlaid upon the graphical interface to receive the filter input via selection and deselection of multiple individual salespersons of a sales team; (ii) a date range filter panel view overlaid upon the graphical interface to receive the filter input via a specified date or date range; (iii) an opportunity stage filter panel view overlaid upon the graphical interface to receive the filter input via selection and deselection of multiple available sales opportunity phases represented by the business analytics dataset; and (iv) an expanded filter panel view overlaid upon the graphical interface to receive the filter input via multiple distinct filter inputs for multiple filterable criteria represented by the business analytics dataset.

According to another embodiment of method 600, the new view includes a record modifier panel view to receive record modification input for a record within the business analytics dataset; and receiving the record modification input at an opportunity record editor of the record modifier panel view.

According to another embodiment, method 600 further includes: updating the business analytics dataset cached at the client device according to the record modification input; and updating the business analytics report displayed at the graphical interface using the updated business analytics dataset, in which the updated business analytics report is generated without a second business analytics query from the client device to the remote host organization.

According to another embodiment, method 600 further includes: updating the business analytics dataset cached at the client device according to the record modification input; and displaying a change value indication panel at the graphical interface displaying thereupon at least a before state and an after state of a business metric affected by the modification input.

According to another embodiment, method 600 further includes: receiving user input to commit the record modification input for the opportunity record to a database record persisted at the host organization; and sending a request to the host organization to update and commit the record modification to the database record persisted at the host organization.

According to another embodiment, method 600 further includes: receiving confirmation of the update and commit of the record modification to the database record persisted at the host organization responsive to the request, in which the confirmation is formed as a confirmation message indicating a successful update and commit of the update and commit of the record modification responsive to the request or a second business analytics dataset having the record modification represented therein returned from the host organization responsive to the request.

According to another embodiment, method 600 further includes: receiving filter input at the client device via one or more filter input panels displayed at the graphical interface; displaying a save filter sets panel view to the graphical interface; receiving a filter set name input at the graphical interface; and saving the filter input as currently applied to the business analytics dataset as a saved filter set according to the filter set name input.

According to another embodiment, method 600 further includes one or more of: synchronizing the saved filter set to the host organization, in which the saved filter set is persisted at the host organization on behalf of an authenticated user of the client device; sharing the saved filter set to other authenticated users affiliated with the host organization responsive to a sharing request by the authenticated user of the client device; retrieving the saved filter set from the host organization at a second client having been authenticated on behalf of the user of the first client device; designating the saved filter set as a default filter set on behalf of the authenticated user of the client device; and receiving a new business analytics dataset responsive to a second business analytics query sent to the host organization from the client device and applying the saved filter set to the new business analytics dataset to yield a second filtered sub-set different than the first filtered sub-set, in which the second filtered sub-set is generated from a cached copy of the new business analytics dataset at the client device.

According to another embodiment, method 600 further includes: receiving benchmark modification input at the client device via the graphical interface; filtering one or more records from the business analytics dataset according to the benchmark modification input; updating the business analytics report displayed at the graphical interface using having the one or more records filtered out; in which the one or more records from the business analytics dataset include at least one of: (i) an individual salesperson record; (ii) records corresponding to a specified sales opportunity phase; (iii) records corresponding to numerical range of sales opportunity amounts; (iv) records corresponding to a range of sales opportunity close dates; and (v) records corresponding to an account.

According to another embodiment, method 600 further includes: displaying a benchmark modifier panel as an overlay to the graphical interface to receive selection and deselection input for one or more business metrics represented within the business analytics dataset as the filter input; in which applying the filter input includes applying the selection and deselection input to the business analytics dataset to yield the filtered sub-set; and in which updating the business analytics report displayed at the graphical interface using the filtered sub-set of the business analytics dataset includes updating the business analytics report displayed according to the selection and deselection input as applied.

According to another embodiment of method 600, the business analytics report displayed at the graphical interface includes at least a bar chart graphically depicting total quota of a sales team having a plurality of individual salespersons therein and total quota attainment of the sales team as an aggregated total for the plurality of individual salespersons; receiving deselection input for at least one of the plurality of individual salespersons of the sales team; filtering the at least one individual salesperson from the business analytics dataset according to the deselection input to yield the filtered sub-set; in which updating the business analytics report displayed at the graphical interface using the filtered sub-set of the business analytics dataset includes updating bar chart, in which the updated bar chart graphically depicts a total quota of all individual salespersons which remain in the filtered sub-set and total quota attainment of all individual salespersons which remain in the filtered sub-set; and in which a quota and a quota attainment of the at least one individual salesperson filtered from the business analytics dataset is non-represented by the updated bar chart.

According to another embodiment of method 600, the business analytics query includes one of a JavaScript Object Notation (JSON) type query or a Structured Query Language (SQL) type query generated at the client device via display logic executed by the processor.

According to another embodiment of method 600, the client device is embodied within one of: a tablet computing device; a hand-held smartphone; and a mobile computing device.

According to a particular embodiment, there is non-transitory computer readable storage media having instructions stored thereon that, when executed by a processor of a client device, the instructions cause the client device to perform operations including: displaying a graphical interface at the client device; communicating a business analytics query from the client device to a remote host organization via a public Internet; receiving a business analytics dataset in a complete and unfiltered form from the host organization responsive to the business analytics query; caching the business analytics dataset in its complete and unfiltered form to the memory of the client device; displaying a business analytics report at the graphical interface of the client device, the business analytics report representative of the business analytics dataset in its complete and unfiltered form; receiving filter input at the client device; applying the filter input to the business analytics dataset to yield a filtered sub-set; and updating the business analytics report displayed at the graphical interface using the filtered sub-set of the business analytics dataset.

With reference to FIG. 6B and method 601 at the host organization, processing logic receives a business analytics query from a remote client device at the host organization via a public Internet (block 650).

At block 655, processing logic executes the business analytics query against a database of the host organization to yield a business analytics dataset.

At block 660, processing logic communicates the business analytics dataset to the remote client device responsive to the business analytics query for display with a business analytics report generated at the remote client device representative of the business analytics dataset.

At block 665, processing logic receives a request from the remote client device to update and commit a record persisted in the database at the host organization.

At block 670, processing logic updates and commits the record in the database.

At block 675, processing logic sends confirmation of the update and commit of the record persisted the database responsive to the request. For instance, the confirmation may be formed as a confirmation message indicating a successful update and commit of the update and commit of the record responsive to the request or the confirmation may be formed as a second business analytics dataset having the updated and committed record persisted in the database of the host organization represented therein, in which the second business analytics dataset is returned to the remote client device responsive to the request to update and commit the record.

According to another embodiment of method 601, the host organization implements the method via computing architecture of the host organization including at least a processor and a memory. In such an embodiment, the host organization operates as a cloud based service provider to the remote client device.

According to another embodiment of method 601, the host organization provides a multi-tenant database system via the databases and the computing architecture of the host organization, the multi-tenant database system having elements of hardware and software that are shared by a plurality of separate and distinct customer organizations, each of the separate and distinct customer organizations being remotely located from the host organization.

According to a particular embodiment, there is non-transitory computer readable storage media having instructions stored thereon that, when executed by a processor of a host organization, the instructions cause the host organization to perform operations including: receiving a business analytics query from a remote client device at the host organization via a public Internet; executing the business analytics query against a database of the host organization to yield a business analytics dataset; communicating the business analytics dataset to the remote client device responsive to the business analytics query for display with a business analytics report generated at the remote client device representative of the business analytics dataset; receiving a request from the remote client device to update and commit a record persisted in the database at the host organization; updating and committing the record in the database; and sending confirmation of the update and commit of the record persisted the database responsive to the request, in which the confirmation is formed as a confirmation message indicating a successful update and commit of the update and commit of the record responsive to the request or a second business analytics dataset having the updated and committed record persisted in the database of the host organization represented therein, the second business analytics dataset being returned to the remote client device responsive to the request to update and commit the record.

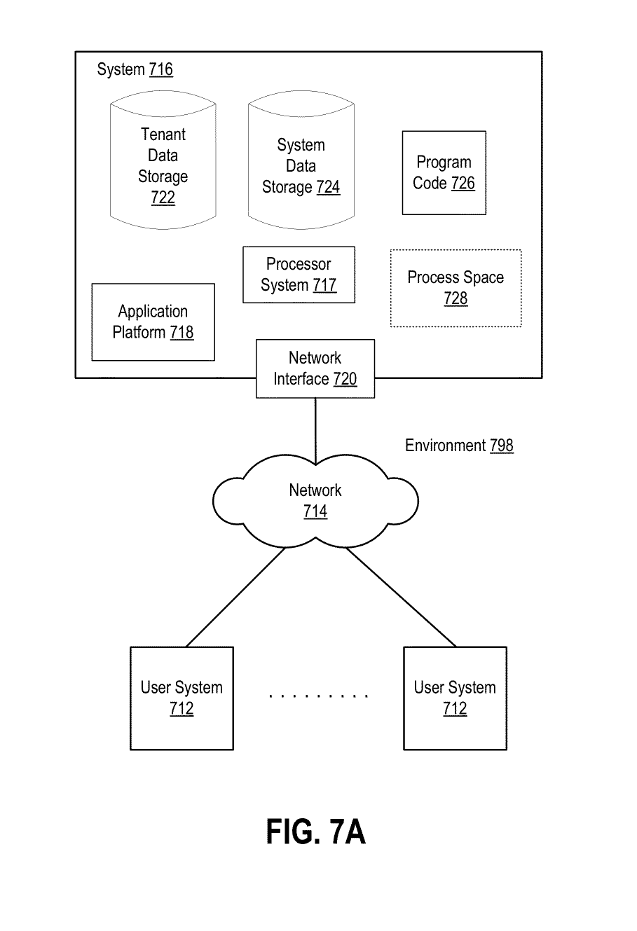

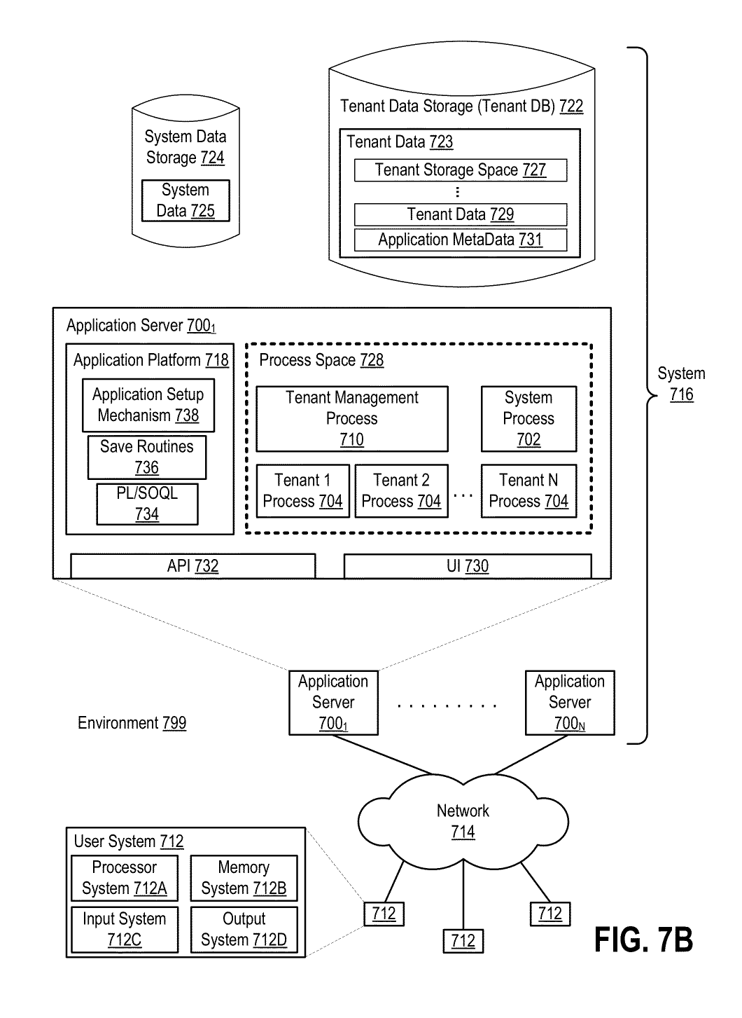

FIG. 7A illustrates a block diagram of an environment 798 in which an on-demand database service may operate in accordance with the described embodiments. Environment 798 may include user systems 712, network 714, system 716, processor system 717, application platform 718, network interface 720, tenant data storage 722, system data storage 724, program code 726, and process space 728. In other embodiments, environment 798 may not have all of the components listed and/or may have other elements instead of, or in addition to, those listed above.

Environment 798 is an environment in which an on-demand database service exists. User system 712 may be any machine or system that is used by a user to access a database user system. For example, any of user systems 712 can be a handheld computing device, a mobile phone, a laptop computer, a work station, and/or a network of computing devices. As illustrated in FIG. 7A (and in more detail in FIG. 7B) user systems 712 might interact via a network 714 with an on-demand database service, which is system 716.

An on-demand database service, such as system 716, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 716” and “system 716” is used interchangeably herein. A database image may include one or more database objects. A relational database management system (RDMS) or the equivalent may execute storage and retrieval of information against the database object(s). Application platform 718 may be a framework that allows the applications of system 716 to run, such as the hardware and/or software, e.g., the operating system. In an embodiment, on-demand database service 716 may include an application platform 718 that enables creation, managing and executing one or more applications developed by the provider of the on-demand database service, users accessing the on-demand database service via user systems 712, or third party application developers accessing the on-demand database service via user systems 712.

The users of user systems 712 may differ in their respective capacities, and the capacity of a particular user system 712 might be entirely determined by permissions (permission levels) for the current user. For example, where a salesperson is using a particular user system 712 to interact with system 716, that user system has the capacities allotted to that salesperson. However, while an administrator is using that user system to interact with system 716, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 714 is any network or combination of networks of devices that communicate with one another. For example, network 714 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it is understood that the networks that the claimed embodiments may utilize are not so limited, although TCP/IP is a frequently implemented protocol.

User systems 712 might communicate with system 716 using TCP/IP and, at a higher network level, use other common Internet protocols to communicate, such as HTTP, FTP, AFS, WAP, etc. In an example where HTTP is used, user system 712 might include an HTTP client commonly referred to as a “browser” for sending and receiving HTTP messages to and from an HTTP server at system 716. Such an HTTP server might be implemented as the sole network interface between system 716 and network 714, but other techniques might be used as well or instead. In some implementations, the interface between system 716 and network 714 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 716, shown in FIG. 7A, implements a web-based customer relationship management (CRM) system. For example, in one embodiment, system 716 includes application servers configured to implement and execute CRM software applications as well as provide related data, code, forms, webpages and other information to and from user systems 712 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 716 implements applications other than, or in addition to, a CRM application. For example, system 716 may provide tenant access to multiple hosted (standard and custom) applications, including a CRM application. User (or third party developer) applications, which may or may not include CRM, may be supported by the application platform 718, which manages creation, storage of the applications into one or more database objects and executing of the applications in a virtual machine in the process space of the system 716.

One arrangement for elements of system 716 is shown in FIG. 7A, including a network interface 720, application platform 718, tenant data storage 722 for tenant data 723, system data storage 724 for system data 725 accessible to system 716 and possibly multiple tenants, program code 726 for implementing various functions of system 716, and a process space 728 for executing MTS system processes and tenant-specific processes, such as running applications as part of an application hosting service. Additional processes that may execute on system 716 include database indexing processes.

Several elements in the system shown in FIG. 7A include conventional, well-known elements that are explained only briefly here. For example, each user system 712 may include a desktop personal computer, workstation, laptop, PDA, cell phone, or any wireless access protocol (WAP) enabled device or any other computing device capable of interfacing directly or indirectly to the Internet or other network connection. User system 712 typically runs an HTTP client, e.g., a browsing program, such as Microsoft's Internet Explorer browser, a Mozilla or Firefox browser, an Opera, or a WAP-enabled browser in the case of a smartphone, tablet, PDA or other wireless device, or the like, allowing a user (e.g., subscriber of the multi-tenant database system) of user system 712 to access, process and view information, pages and applications available to it from system 716 over network 714. Each user system 712 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 716 or other systems or servers. For example, the user interface device can be used to access data and applications hosted by system 716, and to perform searches on stored data, and otherwise allow a user to interact with various GUI pages that may be presented to a user. As discussed above, embodiments are suitable for use with the Internet, which refers to a specific global internetwork of networks. However, it is understood that other networks can be used instead of the Internet, such as an intranet, an extranet, a virtual private network (VPN), a non-TCP/IP based network, any LAN or WAN or the like.

According to one embodiment, each user system 712 and all of its components are operator configurable using applications, such as a browser, including computer code run using a central processing unit such as an Intel Pentium® processor or the like. Similarly, system 716 (and additional instances of an MTS, where more than one is present) and all of their components might be operator configurable using application(s) including computer code to run using a central processing unit such as processor system 717, which may include an Intel Pentium® processor or the like, and/or multiple processor units.

According to one embodiment, each system 716 is configured to provide webpages, forms, applications, data and media content to user (client) systems 712 to support the access by user systems 712 as tenants of system 716. As such, system 716 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS may include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It is understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 7B illustrates another block diagram of an embodiment of elements of FIG. 7A and various possible interconnections between such elements in accordance with the described embodiments. FIG. 7B also illustrates environment 799. However, in FIG. 7B, the elements of system 716 and various interconnections in an embodiment are illustrated in further detail. More particularly, FIG. 7B shows that user system 712 may include a processor system 712A, memory system 712B, input system 712C, and output system 712D. FIG. 7B shows network 714 and system 716. FIG. 7B also shows that system 716 may include tenant data storage 722, having therein tenant data 723, which includes, for example, tenant storage space 727, tenant data 729, and application metadata 731. System data storage 724 is depicted as having therein system data 725. Further depicted within the expanded detail of Application servers 700_{1-N} are User Interface (UI) 730, Application Program Interface (API) 732, application platform 718 includes PL/SOQL 734, save routines 736, application setup mechanism 738, process space 728 includes system process space 702, tenant 1-N process spaces 704, and tenant management process space 710. In other embodiments, environment 799 may not have the same elements as those listed above and/or may have other elements instead of, or in addition to, those listed above.

User system 712, network 714, system 716, tenant data storage 722, and system data storage 724 were discussed above in FIG. 7A. As shown by FIG. 7B, system 716 may include a network interface 720 (of FIG. 7A) implemented as a set of HTTP application servers 700, an application platform 718, tenant data storage 722, and system data storage 724. Also shown is system process space 702, including individual tenant process spaces 704 and a tenant management process space 710. Each application server 700 may be configured to tenant data storage 722 and the tenant data 723 therein, and system data storage 724 and the system data 725 therein to serve requests of user systems 712. The tenant data 723 might be divided into individual tenant storage areas (e.g., tenant storage space 727), which can be either a physical arrangement and/or a logical arrangement of data. Within each tenant storage space 727, tenant data 729 and application metadata 731 might be similarly allocated for each user. For example, a copy of a user's most recently used (MRU) items might be stored to tenant data 729. Similarly, a copy of MRU items for an entire organization that is a tenant might be stored to tenant storage area 727. A UI 730 provides a user interface and an API 732 provides an application programmer interface into system 716 resident processes to users and/or developers at user systems 712. The tenant data and the system data may be stored in various databases, such as one or more Oracle™ databases.

Application platform 718 includes an application setup mechanism 738 that supports application developers' creation and management of applications, which may be saved as metadata into tenant data storage 722 by save routines 736 for execution by subscribers as one or more tenant process spaces 704 managed by tenant management process space 710 for example. Invocations to such applications may be coded using PL/SOQL 734 that provides a programming language style interface extension to API 732. Invocations to applications may be detected by one or more system processes, which manages retrieving application metadata 731 for the subscriber making the invocation and executing the metadata as an application in a virtual machine.

Each application server 700 may be communicably coupled to database systems, e.g., having access to system data 725 and tenant data 723, via a different network connection. For example, one application server 700₁ might be coupled via the network 714 (e.g., the Internet), another application server 700_{N-1} might be coupled via a direct network link, and another application server 700_{N} might be coupled by yet a different network connection. Transfer Control Protocol and Internet Protocol (TCP/IP) are typical protocols for communicating between application servers 700 and the database system. However, it will be apparent to one skilled in the art that other transport protocols may be used to optimize the system depending on the network interconnect used.

In certain embodiments, each application server 700 is configured to handle requests for any user associated with any organization that is a tenant. Because it is desirable to be able to add and remove application servers from the server pool at any time for any reason, there is preferably no server affinity for a user and/or organization to a specific application server 700. In one embodiment, therefore, an interface system implementing a load balancing function (e.g., an F5 Big-IP load balancer) is communicably coupled between the application servers 700 and the user systems 712 to distribute requests to the application servers 700. In one embodiment, the load balancer uses a least connections algorithm to route user requests to the application servers 700. Other examples of load balancing algorithms, such as round robin and observed response time, also can be used. For example, in certain embodiments, three consecutive requests from the same user may hit three different application servers 700, and three requests from different users may hit the same application server 700. In this manner, system 716 is multi-tenant, in which system 716 handles storage of, and access to, different objects, data and applications across disparate users and organizations.

As an example of storage, one tenant might be a company that employs a sales force where each salesperson uses system 716 to manage their sales process. Thus, a user might maintain contact data, leads data, customer follow-up data, performance data, goals and progress data, etc., all applicable to that user's personal sales process (e.g., in tenant data storage 722). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 716 that are allocated at the tenant level while other data structures might be managed at the user level. Because an MTS might support multiple tenants including possible competitors, the MTS may have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 716 might also maintain system level data usable by multiple tenants or other data. Such system level data might include industry reports, news, postings, and the like that are sharable among tenants.

In certain embodiments, user systems 712 (which may be client systems) communicate with application servers 700 to request and update system-level and tenant-level data from system 716 that may require sending one or more queries to tenant data storage 722 and/or system data storage 724. System 716 (e.g., an application server 700 in system 716) automatically generates one or more SQL statements (e.g., one or more SQL queries) that are designed to access the desired information. System data storage 724 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects as described herein. It is understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It is understood that the word “entity” may also be used interchangeably herein with “object” and “table.”

In some multi-tenant database systems, tenants may be allowed to create and store custom objects, or they may be allowed to customize standard entities or objects, for example by creating custom fields for standard objects, including custom index fields. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

FIG. 8 illustrates a diagrammatic representation of a machine 800 in the exemplary form of a computer system, in accordance with one embodiment, within which a set of instructions, for causing the machine/computer system 800 to perform any one or more of the methodologies discussed herein, may be executed. In alternative embodiments, the machine may be connected (e.g., networked) to other machines in a Local Area Network (LAN), an intranet, an extranet, or the public Internet. The machine may operate in the capacity of a server or a client machine in a client-server network environment, as a peer machine in a peer-to-peer (or distributed) network environment, as a server or series of servers within an on-demand service environment. Certain embodiments of the machine may be in the form of a personal computer (PC), a tablet PC, a set-top box (STB), a Personal Digital Assistant (PDA), a cellular telephone, a web appliance, a server, a network router, switch or bridge, computing system, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The exemplary computer system 800 includes a processor 802, a main memory 804 (e.g., read-only memory (ROM), flash memory, dynamic random access memory (DRAM) such as synchronous DRAM (SDRAM) or Rambus DRAM (RDRAM), etc., static memory such as flash memory, static random access memory (SRAM), volatile but high-data rate RAM, etc.), and a secondary memory 818 (e.g., a persistent storage device including hard disk drives and a persistent database and/or a multi-tenant database implementation), which communicate with each other via a bus 830. Main memory 804 includes query builder 824 to generate, build, or otherwise configure business analytics queries and update queries in pursuance of the described embodiments. Main memory 804 further includes an analysis engine 823 capable of evaluating and applying deselection and selection events, filter input, context determinations, etc. Main memory 804 further includes cached datasets 825, such as received business analytic datasets in their complete and unfiltered form such that filtering may be applied to the full and complete datasets without having to re-query a remote host organization. Main memory 804 and its sub-elements are operable in conjunction with processing logic 826 and processor 802 to perform the methodologies discussed herein. The computer system 800 may additionally or alternatively embody the server side elements as described above.

Processor 802 represents one or more general-purpose processing devices such as a microprocessor, central processing unit, or the like. More particularly, the processor 802 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processor 802 may also be one or more special-purpose processing devices such as an application specific integrated circuit (ASIC), a field programmable gate array (FPGA), a digital signal processor (DSP), network processor, or the like. Processor 802 is configured to execute the processing logic 826 for performing the operations and functionality which is discussed herein.

The computer system 800 may further include a network interface card 808. The computer system 800 also may include a user interface 810 (such as a video display unit, a liquid crystal display (LCD), or a cathode ray tube (CRT)), an alphanumeric input device 812 (e.g., a keyboard), a cursor control device 814 (e.g., a mouse), and a signal generation device 816 (e.g., an integrated speaker). The computer system 800 may further include peripheral device 836 (e.g., wireless or wired communication devices, memory devices, storage devices, audio processing devices, video processing devices, etc.).

The secondary memory 818 may include a non-transitory machine-readable or computer readable storage medium 831 on which is stored one or more sets of instructions (e.g., software 822) embodying any one or more of the methodologies or functions described herein. The software 822 may also reside, completely or at least partially, within the main memory 804 and/or within the processor 802 during execution thereof by the computer system 800, the main memory 804 and the processor 802 also constituting machine-readable storage media. The software 822 may further be transmitted or received over a network 820 via the network interface card 808.

FIG. 9A depicts a tablet computing device 901 and a hand-held smartphone 902 each having a circuitry integrated therein as described in accordance with the embodiments. As depicted, each of the tablet computing device 901 and the hand-held smartphone 902 include a touchscreen interface 903 and an integrated processor 904 in accordance with disclosed embodiments.

For example, in one embodiment, a system embodies a tablet computing device 901 or a hand-held smartphone 902, in which a display unit of the system includes a touchscreen interface 903 for the tablet or the smartphone and further in which memory and an integrated circuit operating as an integrated processor are incorporated into the tablet or smartphone, in which the integrated processor implements one or more of the embodiments described herein for displaying and filtering business analytics data stored in the cloud and interfacing to an on-demand and/or multi-tenant database system such as a cloud computing service provided via a public Internet as a subscription service. In one embodiment, the integrated circuit described above or the depicted integrated processor of the tablet or smartphone is an integrated silicon processor functioning as a central processing unit (CPU) and/or a Graphics Processing Unit (GPU) for a tablet computing device or a smartphone.

FIG. 9B is a block diagram 900 of an embodiment of tablet computing device, a smart phone, or other mobile device in which touchscreen interface connectors are used. Processor 910 performs the primary processing operations. Audio subsystem 920 represents hardware (e.g., audio hardware and audio circuits) and software (e.g., drivers, codecs) components associated with providing audio functions to the computing device. In one embodiment, a user interacts with the tablet computing device or smart phone by providing audio commands that are received and processed by processor 910.

Display subsystem 930 represents hardware (e.g., display devices) and software (e.g., drivers) components that provide a visual and/or tactile display for a user to interact with the tablet computing device or smart phone. Display subsystem 930 includes display interface 932, which includes the particular screen or hardware device used to provide a display to a user. In one embodiment, display subsystem 930 includes a touchscreen device that provides both output and input to a user.

I/O controller 940 represents hardware devices and software components related to interaction with a user. I/O controller 940 can operate to manage hardware that is part of audio subsystem 920 and/or display subsystem 930. Additionally, I/O controller 940 illustrates a connection point for additional devices that connect to the tablet computing device or smart phone through which a user might interact. In one embodiment, I/O controller 940 manages devices such as accelerometers, cameras, light sensors or other environmental sensors, or other hardware that can be included in the tablet computing device or smart phone. The input can be part of direct user interaction, as well as providing environmental input to the tablet computing device or smart phone.

In one embodiment, the tablet computing device or smart phone includes power management 950 that manages battery power usage, charging of the battery, and features related to power saving operation. Memory subsystem 960 includes memory devices for storing information in the tablet computing device or smart phone. Connectivity 970 includes hardware devices (e.g., wireless and/or wired connectors and communication hardware) and software components (e.g., drivers, protocol stacks) to the tablet computing device or smart phone to communicate with external devices. Cellular connectivity 972 may include, for example, wireless carriers such as GSM (global system for mobile communications), CDMA (code division multiple access), TDM (time division multiplexing), or other cellular service standards). Wireless connectivity 974 may include, for example, activity that is not cellular, such as personal area networks (e.g., Bluetooth), local area networks (e.g., WiFi), and/or wide area networks (e.g., WiMax), or other wireless communication.

Peripheral connections 980 include hardware interfaces and connectors, as well as software components (e.g., drivers, protocol stacks) to make peripheral connections as a peripheral device (“to” 982) to other computing devices, as well as have peripheral devices (“from” 984) connected to the tablet computing device or smart phone, including, for example, a “docking” connector to connect with other computing devices. Peripheral connections 980 include common or standards-based connectors, such as a Universal Serial Bus (USB) connector, DisplayPort including MiniDisplayPort (MDP), High Definition Multimedia Interface (HDMI), Firewire, etc.

FIG. 10 shows a diagrammatic representation of a mobile computing device 1000 in which embodiments may operate, be installed, integrated, or configured.

In accordance with one embodiment, there is a mobile computing device 1000 having at least a processor 1090 and a memory 1095 there to execute display logic and/or instructions 1096. According to such an embodiment, the mobile computing device 1000 further includes a touchscreen display 1025 to display or render a graphical interface at the mobile computing device 1000; a network interface 1035 to communicate a business analytics query from the mobile computing device 1000 to a remote host organization via a public Internet. Such a business analytics query may be built, generated, or configured via the query builder 1055 depicted. In accordance with embodiments, the network interface 1035 may further receive a business analytics dataset 1099 in a complete and unfiltered form from the host organization responsive to the business analytics query, in which the memory 1095 is to cache 1075 the business analytics dataset 1099 in its complete and unfiltered form. According to such embodiments, the touchscreen display 1025 is to further render or display a business analytics report at the graphical interface of the mobile computing device 1000, in which the business analytics report is representative of the business analytics dataset 1099 in its complete and unfiltered form. According to such embodiments, the touchscreen display 1025 is to further receive filter input at the graphical interface of the mobile computing device pursuant to which an analysis engine 1050 is to apply the filter input to the business analytics dataset to yield a filtered sub-set 1098. Display logic or instructions 1096 are to further update the business analytics report displayed at the graphical interface displayed upon the touchscreen display 1025 using the filtered sub-set 1098 of the business analytics dataset.

Bus 1015 interfaces the various components of the mobile computing device 1000 amongst each other, with the remote host organization via the network interface 1035, and with any other peripheral(s) 1030 of the mobile computing device 1000.

According to another embodiment, the mobile computing device 1000 is embodied within one of a tablet computing device or a hand-held smartphone such as those depicted at FIGS. 9A and 9B.

While the subject matter disclosed herein has been described by way of example and in terms of the specific embodiments, it is to be understood that the claimed embodiments are not limited to the explicitly enumerated embodiments disclosed. To the contrary, the disclosure is intended to cover various modifications and similar arrangements as are apparent to those skilled in the art. Therefore, the scope of the appended claims are to be accorded the broadest interpretation so as to encompass all such modifications and similar arrangements. It is to be understood that the above description is intended to be illustrative, and not restrictive. Many other embodiments will be apparent to those of skill in the art upon reading and understanding the above description. The scope of the disclosed subject matter is therefore to be determined in reference to the appended claims, along with the full scope of equivalents to which such claims are entitled.

What is claimed is:

1. A method at a client device having at least a processor and a memory therein, wherein the method comprises:
displaying a graphical interface at the client device;
communicating a business analytics query from the client device to a remote host organization via a public Internet;
receiving a business analytics dataset in a complete and unfiltered form from the host organization responsive to the business analytics query;
caching the business analytics dataset in its complete and unfiltered form to the memory of the client device;
displaying a business analytics report at the graphical interface of the client device, the business analytics report representative of the business analytics dataset in its complete and unfiltered form;
receiving filter input at the client device;
applying the filter input to the business analytics dataset to yield a filtered sub-set; and
updating the business analytics report displayed at the graphical interface using the filtered sub-set of the business analytics dataset.

2. The method of claim 1, wherein updating the business analytics report displayed at the graphical interface comprises generating the updated business analytics report without a second business analytics query from the client device to the remote host organization.

3. The method of claim 1, further comprising:
receiving new filter input at the client device;
applying the new filter input to the business analytics dataset in its complete and unfiltered form to yield a second filtered sub-set different than the first filtered sub-set, wherein the second filtered sub-set is generated from the cache of the client device having the business analytics dataset in its complete and unfiltered form stored therein; and
updating the business analytics report displayed at the graphical interface using the second filtered sub-set of the business analytics dataset.

4. The method of claim 1, wherein displaying a business analytics report at the graphical interface of the client device, comprises:
displaying at least a scrollable list view at the graphical interface of the client device having a quantity of records equal in number to a quantity of records within the business analytics dataset in its complete and unfiltered form; and
wherein any records of the scrollable list view which exceed a display range of the client device are displayable within the scrollable list view displayed via a scroll interface of the graphical interface responsive to user input.

5. The method of claim 1, wherein displaying a business analytics report at the graphical interface of the client device, comprises:
displaying a dashboard view at the graphical interface of the client device, wherein the dashboard view comprises at least:
(i) a quantity of records equal in number to a quantity of records within the business analytics dataset in its complete and unfiltered form rendered via a scrollable list view; and
(ii) a plurality of business metrics rendered in graphical and numeric form having been calculated from the business analytics dataset in its complete and unfiltered form.

6. The method of claim 5:
wherein the quantity of records of the dashboard view comprises a listing of all sales opportunity records present within the business analytics dataset in its complete and unfiltered form; and
wherein the plurality of business metrics rendered to the dashboard view comprises a total sales quota attainment for a period in numeric form and as a graphical pie chart.

7. The method of claim 1, further comprising:
authenticating a user of the client device with the host organization as a known subscriber;
generating the business analytics query based on a context of the known subscriber; and
wherein the business analytics dataset in its complete and unfiltered form corresponds in scope to the context of the known subscriber.

8. The method of claim 7, wherein the context of the known subscriber is selected from the group comprising:
an individual salesperson having no subordinates, wherein the business analytics dataset comprises a plurality of records associated with the individual salesperson;
a sales manager having as subordinates a sales team of multiple individual salespersons, wherein the business analytics dataset comprises a plurality of records associated with the multiple individual salespersons; and
a business executive having as subordinates, multiple sales managers, each having one or more sales teams of multiple individual salespersons, wherein the business analytics dataset comprises a plurality of records associated with the multiple sales teams.

9. The method of claim 1, further comprising:
receiving user selection input at a graphical element of the business analytics report displayed at the graphical interface;
generating a new view for display to the graphical interface based on a context of the graphical element corresponding to the selection input, wherein the new view includes a sub-set of the business analytics dataset restricted according to the context; and
displaying the new view to the graphical interface.

10. The method of claim 9, wherein the graphical element corresponds to one of:
a navigational icon displayed at the graphical interface;
a record displayed at the graphical interface;
a field of a record displayed at the graphical interface;
a business metric displayed in numeric form at the graphical interface; and
a business metric displayed in graphical form at the graphical interface.

11. The method of claim 9, wherein the new view is selected from the group comprising:
(i) an opportunity stage overview having therein a plurality of sales opportunity stages represented by the business analytics dataset with sales opportunity amount numerically depicted per sales opportunity stage;
(ii) a total quota overview for a sales team depicting total quota for the sales team and total quota attainment for the sales team;
(iii) an opportunity records view having therein a plurality of opportunity records displayed with at least an account name, an account owner, and a sales opportunity amount per opportunity record;
(iv) a team compare view having therein total bookings against total quota for a sales team and quota attainment toward goal per sales individual of the sales team;
(v) a team member records view having therein a plurality of individual salespersons records displayed with at least a salesperson name, a salesperson quota, and a salesperson quota attainment per individual salespersons record;
(vi) a visualizations view having therein a plurality of snapshots corresponding to multiple individual salespersons records of a sales team, each snapshot including at least a salespersons image or likeness, a salesperson name, a salesperson quota, and a salesperson quota attainment per individual salespersons record; and
(vii) a team opportunities view having displayed therein at least a graphical pie chart graphing multiple sales opportunities represented within the business analytics dataset, each of the multiple sales opportunities graphic in visual proportion of sales amount per sales opportunity to a total sales opportunities amount for the multiple sales opportunities graphed.

12. The method of claim 9, wherein the new view is selected from the group comprising:
(i) a team member filter panel view overlaid upon the graphical interface to receive the filter input via selection and deselection of multiple individual salespersons of a sales team;
(ii) a date range filter panel view overlaid upon the graphical interface to receive the filter input via a specified date or date range;
(iii) an opportunity stage filter panel view overlaid upon the graphical interface to receive the filter input via selection and deselection of multiple available sales opportunity phases represented by the business analytics dataset; and
(iv) an expanded filter panel view overlaid upon the graphical interface to receive the filter input via multiple distinct filter inputs for multiple filterable criteria represented by the business analytics dataset.

13. The method of claim 9:
wherein the new view comprises a record modifier panel view to receive record modification input for a record within the business analytics dataset; and
receiving the record modification input at an opportunity record editor of the record modifier panel view.

14. The method of claim 13, further comprising:
updating the business analytics dataset cached at the client device according to the record modification input; and
updating the business analytics report displayed at the graphical interface using the updated business analytics dataset, wherein the updated business analytics report is generated without a second business analytics query from the client device to the remote host organization.

15. The method of claim 13, further comprising:
updating the business analytics dataset cached at the client device according to the record modification input; and
displaying a change value indication panel at the graphical interface displaying thereupon at least a before state and an after state of a business metric affected by the modification input.

16. The method of claim 13, further comprising:
receiving user input to commit the record modification input for the opportunity record to a database record persisted at the host organization; and
sending a request to the host organization to update and commit the record modification to the database record persisted at the host organization.

17. The method of claim 16, further comprising:
receiving confirmation of the update and commit of the record modification to the database record persisted at the host organization responsive to the request, wherein the confirmation is formed as a confirmation message indicating a successful update and commit of the update and commit of the record modification responsive to the request or a second business analytics dataset having the record modification represented therein returned from the host organization responsive to the request.

18. The method of claim 1, further comprising:
receiving filter input at the client device via one or more filter input panels displayed at the graphical interface;
displaying a save filter sets panel view to the graphical interface;
receiving a filter set name input at the graphical interface; and
saving the filter input as currently applied to the business analytics dataset as a saved filter set according to the filter set name input.

19. The method of claim 18, further comprising one or more of:
synchronizing the saved filter set to the host organization, wherein the saved filter set is persisted at the host organization on behalf of an authenticated user of the client device;
sharing the saved filter set to other authenticated users affiliated with the host organization responsive to a sharing request by the authenticated user of the client device;
retrieving the saved filter set from the host organization at a second client having been authenticated on behalf of the user of the first client device;
designating the saved filter set as a default filter set on behalf of the authenticated user of the client device; and
receiving a new business analytics dataset responsive to a second business analytics query sent to the host organization from the client device and applying the saved filter set to the new business analytics dataset to yield a second filtered sub-set different than the first filtered sub-set, wherein the second filtered sub-set is generated from a cached copy of the new business analytics dataset at the client device.

20. The method of claim 1, further comprising:
receiving benchmark modification input at the client device via the graphical interface;
filtering one or more records from the business analytics dataset according to the benchmark modification input;
updating the business analytics report displayed at the graphical interface using having the one or more records filtered out;
wherein the one or more records from the business analytics dataset include at least one of:
(i) an individual salesperson record;
(ii) records corresponding to a specified sales opportunity phase;
(iii) records corresponding to numerical range of sales opportunity amounts;
(iv) records corresponding to a range of sales opportunity close dates; and
(v) records corresponding to an account.

21. The method of claim 1, further comprising:
displaying a benchmark modifier panel as an overlay to the graphical interface to receive selection and deselection input for one or more business metrics represented within the business analytics dataset as the filter input;
wherein applying the filter input comprises applying the selection and deselection input to the business analytics dataset to yield the filtered sub-set; and
wherein updating the business analytics report displayed at the graphical interface using the filtered sub-set of the business analytics dataset comprises updating the business analytics report displayed according to the selection and deselection input as applied.

22. The method of claim 1:
wherein the business analytics report displayed at the graphical interface comprises at least a bar chart graphically depicting total quota of a sales team having a plurality of individual salespersons therein and total quota attainment of the sales team as an aggregated total for the plurality of individual salespersons;
receiving deselection input for at least one of the plurality of individual salespersons of the sales team;
filtering the at least one individual salesperson from the business analytics dataset according to the deselection input to yield the filtered sub-set;
wherein updating the business analytics report displayed at the graphical interface using the filtered sub-set of the business analytics dataset comprises updating bar chart, wherein the updated bar chart graphically depicts a total quota of all individual salespersons which remain in the filtered sub-set and total quota attainment of all individual salespersons which remain in the filtered sub-set; and
wherein a quota and a quota attainment of the at least one individual salesperson filtered from the business analytics dataset is non-represented by the updated bar chart.

23. The method of claim 1, wherein the business analytics query comprises one of a JavaScript Object Notation (JSON) type query or a Structured Query Language (SQL) type query generated at the client device via display logic executed by the processor.

24. The method of claim 1, wherein the client device having at least the memory and the processor therein is embodied within one of:
a tablet computing device;
a hand-held smartphone; and
a mobile computing device.

25. A method in a host organization, wherein the method comprises:
receiving a business analytics query from a remote client device at the host organization via a public Internet;
executing the business analytics query against a database of the host organization to yield a business analytics dataset;
communicating the business analytics dataset to the remote client device responsive to the business analytics query for display with a business analytics report generated at the remote client device representative of the business analytics dataset;
receiving a request from the remote client device to update and commit a record persisted in the database at the host organization;
updating and committing the record in the database; and
sending confirmation of the update and commit of the record persisted the database responsive to the request, wherein the confirmation is formed as a confirmation message indicating a successful update and commit of the update and commit of the record responsive to the request or a second business analytics dataset having the updated and committed record persisted in the database of the host organization represented therein, the second business analytics dataset being returned to the remote client device responsive to the request to update and commit the record.

26. The method of claim 25:
wherein the host organization implements the method via computing architecture of the host organization including at least a processor and a memory;
wherein the host organization operates as a cloud based service provider to the remote client device; and
wherein the host organization provides a multi-tenant database system via the databases and the computing architecture of the host organization, the multi-tenant database system having elements of hardware and software that are shared by a plurality of separate and distinct customer organizations, each of the separate and distinct customer organizations being remotely located from the host organization.

27. Non-transitory computer readable storage media having instructions stored thereon that, when executed by a processor of a client device, the instructions cause the client device to perform operations comprising:
displaying a graphical interface at the client device;
communicating a business analytics query from the client device to a remote host organization via a public Internet;
receiving a business analytics dataset in a complete and unfiltered form from the host organization responsive to the business analytics query;
caching the business analytics dataset in its complete and unfiltered form to the memory of the client device;
displaying a business analytics report at the graphical interface of the client device, the business analytics report representative of the business analytics dataset in its complete and unfiltered form;
receiving filter input at the client device;
applying the filter input to the business analytics dataset to yield a filtered sub-set; and
updating the business analytics report displayed at the graphical interface using the filtered sub-set of the business analytics dataset.

28. A mobile computing device comprising:
a processor and a memory to execute instructions at the mobile computing device;
a touchscreen to display a graphical interface at the mobile computing device;
a network interface to communicate a business analytics query from the mobile client device to a remote host organization via a public Internet;
the network interface to receive a business analytics dataset in a complete and unfiltered form from the host organization responsive to the business analytics query;
the memory to cache the business analytics dataset in its complete and unfiltered form;
touchscreen to display a business analytics report at the graphical interface of the mobile client device, the business analytics report representative of the business analytics dataset in its complete and unfiltered form;
the touchscreen to receive filter input at the graphical interface of the mobile computing device;
an analysis engine to apply the filter input to the business analytics dataset to yield a filtered sub-set; and
display logic to update the business analytics report displayed at the graphical interface displayed upon the touchscreen using the filtered sub-set of the business analytics dataset.

29. The mobile computing device of claim 28, wherein the mobile computing device is embodied within one of
a tablet computing device; and
a hand-held smartphone.
